(19) United States
(12) Patent Application Publication
(10) Pub. No.: US 2026/0093203 A1
(43) Pub. Date: Apr. 2, 2026

(54) IMAGE FORMING APPARATUS

(71) Applicant: CANON KABUSHIKI KAISHA, Tokyo (JP)

(72) Inventors: KAZUHIRO DODA, Kanagawa (JP); KOJI AN, Saitama (JP); TSUGUHIRO YOSHIDA, Kanagawa (JP)

(21) Appl. No.: 19/324,910

(22) Filed: Sep. 10, 2025

(30) Foreign Application Priority Data
Sep. 11, 2024 (JP) 2024-157751

(51) Int. Cl. G03G 21/10; G03G 15/00; G03G 15/01; G03G 15/02; G03G 15/043

(52) U.S. Cl. CPC G03G 21/10; G03G 15/0189; G03G 15/0266; G03G 15/043; G03G 15/5004; G03G 15/5041; G03G 2215/00037; G03G 2221/1606; G03G 2221/1627

(57) ABSTRACT

Provided is an image forming apparatus that forms a toner image by developing an electrostatic latent image which is formed by charging and exposing an image bearing member, and transfers the toner image onto a transferred member. The image forming apparatus can perform developer collection to return a toner image on the image bearing member to developing unit. The image forming apparatus sets a first area in accordance with the toner density and a second area in which density is higher than the first area, along a rotating shaft direction in a collected area which is a target of developer collection, and performs control so that a second back contrast in the second area is higher than a first back contrast in the first area in a case of the developer collection.

### BACKGROUND

### Field of the Technology

The present disclosure relates to an image forming apparatus.

### Description of the Related Art

As an image forming apparatus, such as a copier and a laser beam printer, an image forming apparatus having a configuration using an intermediate transfer member is known. In this image forming apparatus, as a primary transfer step, a toner image formed on a surface of a photosensitive drum (image bearing member) is transferred onto an intermediate transfer member by applying voltage from a voltage power supply to a primary transfer member, which is disposed facing the photosensitive drum. In a case of a full color printer or the like, which forms a color image constituted of a plurality of colors, this primary transfer step is executed for each color, and a toner image of each color is superimposed on each other, whereby a toner image constituted of a plurality of colors is formed on the surface of the intermediate transfer member. Then as a secondary transfer step, the toner images of a plurality of colors, which are formed on the surface of the intermediate transfer member, are transferred onto the surface of a recording material (e.g. paper) by applying voltage to the secondary transfer member. The transferred toner image is then permanently fixed to the recording material by fixing member, whereby a color image is formed.

In this image forming apparatus, in some cases toner may remain on the photosensitive drum without being transferred onto the paper. For example, in the primary transfer step, toner may remain on the photosensitive drum without being transferred to the intermediate transfer member (called “untransferred toner”), or in a case where the image forming operation stops midway (e.g. due to paper jamming), a toner image in the middle of image formation may remain on the photosensitive drum. Therefore before starting the next image formation, the toner remaining on the paper without being transferred (defined as “residual toner”) must be removed (cleaned) from the photosensitive drum.

Japanese Patent Laid-Open No. 2023-074989 discloses means for removing residual toner from the photosensitive drum. Here the residual toner on the photosensitive drum is collected by a developing roller (called “developer collection”) using the potential difference between surface potential Vd on the photosensitive drum and developing roller potential Vdc, which is generated by controlling the voltage applied to the photosensitive drum and the developing roller (this potential difference is called “back contrast ΔVb”). It is disclosed that the collection capability of the developing roller is higher as the potential difference between the photosensitive drum potential Vd and the developing roller potential Vdc (back contrast ΔVb) is higher.

### SUMMARY

The present disclosure provides an image forming apparatus comprising:
an image bearing member;
a charging unit for charging the image bearing member;
an exposing unit for exposing the image bearing member and forming an electrostatic latent image;
a developing unit for supplying toner to the electrostatic latent image on the image bearing member and forming a toner image;
a transfer unit for transferring the toner image formed on the image bearing member to a transferred member;
a control unit configured to control charging voltage applied to the charging unit, developing voltage applied to the developing unit, transfer voltage applied to the transfer unit, and exposure amount by the exposing unit; and
an image information acquiring unit for acquiring information related to density of the toner image formed on the image bearing member, wherein
in a collected area which is a predetermined range of the image bearing member in a direction along a rotating shaft line thereof, the control unit can perform developer collection, that is, returning the toner image formed on the image bearing member to the developing unit without transferring the toner image onto the transferred member,
in a case where an absolute value of a difference between a surface potential of the image bearing member to return the toner image to the developing unit and the developing voltage defines a back contrast, the image information acquiring unit sets a first area and a second area in which density of toner is higher than the first area, to be disposed in a direction along the rotating shaft line in the collected area, and
the control unit performs control so that a second back contrast of the second area during the developer collection is higher than a first back contrast of the first area.

The present disclosure also provides an image forming apparatus comprising:
an image bearing member configured to be rotatable;
a charging unit for charging the image bearing member;
an exposing unit for exposing the image bearing member and forming an electrostatic latent image;
a developing unit for supplying toner to the electrostatic latent image on the image bearing member and forming a toner image;
a transfer unit for transferring the toner image formed on the image bearing member to a transferred member;
a control unit configured to control charging voltage applied to the charging unit, developing voltage applied to the developing unit, transfer voltage applied to the transfer unit, and exposure amount by the exposing unit; and
an image information acquiring unit for acquiring information related to the toner image formed on the image bearing member, wherein
the charging unit, the exposing unit, the developing unit and the transfer unit are disposed in order from an upstream side in a rotating direction of the image bearing member, and
the image forming apparatus can operate in an image forming mode in which the toner image formed on the image bearing member is transferred onto the transferred member, and a discharge mode in which the developing unit supplies discharge doner to the image bearing member, and the developing unit collects a part of the discharge toner and transfers another part of the discharge toner onto the transferred member, wherein
in the discharge mode, the image information acquiring unit divides the toner image into a plurality of areas, calculates an average print percentage in each of the plurality of areas as information on the toner image, and the control unit controls density of the discharge toner for each area based on the average print percentage.

Features of the present disclosure will become apparent from the following description of embodiments with reference to the attached drawings. The following description of embodiments is described by way of example.

### BRIEF DESCRIPTION OF THE DRAWINGS

FIGS. 1A to 1C are diagrams for describing a pixel information detection result and back contrast.

FIG. 2 is a cross-sectional view for describing an image forming apparatus having features of Embodiment 1.

FIG. 3 is a diagram for describing control of image forming process according to an embodiment.

FIG. 4 is a diagram for describing control of weak exposure in the image forming process according to an embodiment.

FIG. 5 is a diagram for describing an outline of developing unit.

FIG. 6 is a diagram for describing toner according to an embodiment.

FIGS. 7A to 7D are diagrams for describing operations of development and developer collection.

FIGS. 8A and 8B are diagrams for describing a toner image when image forming operation according to an embodiment is interrupted.

FIGS. 9A to 9E are diagrams for describing developer collection processing after image forming operation according to an embodiment is interrupted.

FIGS. 10A and 10B are diagrams for describing an image used for verification of Embodiment 1.

FIGS. 11A to 11C are diagrams for describing a pixel information detection result in an area Q of Embodiment 1.

FIGS. 12A to 12C are diagrams for describing contribution degree of back contrast of Embodiment 1.

FIGS. 13A to 13F are diagrams for describing a pixel information detection result in an area Q of Embodiment 2.

FIGS. 14A to 14C are diagrams for describing contribution degree of back contrast of Embodiment 2.

FIGS. 15A to 15F are diagrams for describing discharge control according to Embodiment 3.

FIG. 16 is a diagram for describing voltage and potential control of the discharge control according to Embodiment 3.

FIGS. 17A and 17B are diagrams for describing division of paper area according to Embodiment 3.

FIG. 18 is a graph for describing a number of feeding sheets, print percentage and deteriorated toner ratio according to Embodiment 3.

FIGS. 19A to 19C are diagrams for describing an average print percentage and density of discharge toner according to Embodiment 3.

### DESCRIPTION OF THE EMBODIMENTS

Embodiments of the present disclosure will now be described with reference to the drawings. Dimensions, materials, shapes, relative arrangement and the like of components described in the following embodiments should be appropriately changed depending on the configurations and various conditions of the apparatus to which the present disclosure is applied. Therefore unless otherwise specified, this description is not intended to limit the scope of the present disclosure. In the embodiments, a plurality of features are described, but all of these features are not always essential to implement the disclosure, and these features may be arbitrarily combined.

According to examination by the inventor, in a case where the normal charging polarity of toner is negative, toner, having positive polarity plus charges (reversed polarity of normal charging polarity), exists at a certain ratio, even if most of the toner adhering to the surface of the developing roller has negative polarity minus charges. In this toner, if the developer collection is performed by controlling the photosensitive drum potential Vd to −600V, the developing roller potential Vdc to −300V, and the back contrast ΔVb to 300V, then toner having plus charges is attracted to the surface of the photosensitive drum on the side where negative polarity potential is high. This phenomena is called “reverse fogging”, and the attracted toner is called “reverse fogging toner”.

If the back contrast ΔVb is increased to improve efficiency of the developer collection, the reverse fogging toner increases. The reverse fogging toner adheres to the surface of the charging unit which charges the photosensitive drum, and accumulates on the surface. The charging performance of the charging unit may be diminished thereby.

Therefore in the case of the image forming apparatus which collects toner on the photosensitive drum by the developing roller, it is necessary to implement both the developer collection and reduction of the reverse fogging toner amount.

### Embodiment 1

### Description on Image Forming Apparatus

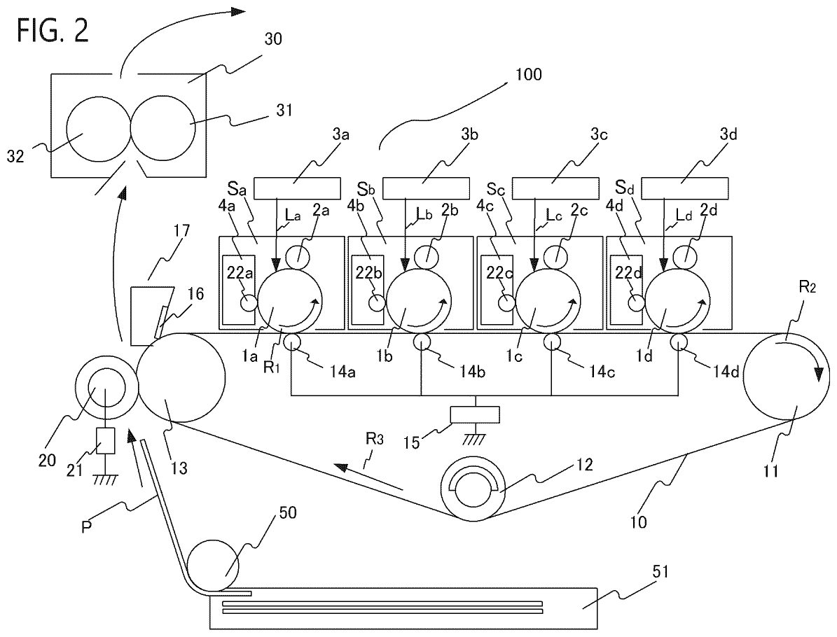

General configuration of an electrophotographic image forming apparatus (hereafter “image forming apparatus”) according to the present disclosure will be described first. FIG. 2 is a schematic cross-sectional view of the image forming apparatus 100 of this embodiment. Configuration, operation and control of the image forming apparatus of this embodiment will be described with reference to FIG. 2.

The image forming apparatus 100 of this embodiment is a full color laser printer using an inline type intermediate transfer system. The image forming apparatus 100 can form a full color image on a recording material P (e.g. recording paper, plastic sheet) according to image information. The image information is inputted to the image forming apparatus 100 from an image reader or a host computer 199 (e.g. personal computer) which is communicably connected to the image forming apparatus 100.

The image forming apparatus 100 includes a plurality of image forming units, which are first, second, third and fourth process cartridges Sa, Sb, Sc and Sd to form each color of an image of yellow (Y), magenta (M), cyan (C) and black (K) respectively. In this embodiment, the first to fourth process cartridges Sa, Sb, Sc and Sd are disposed in a line in a direction crossing with the vertical direction. In this embodiment, configuration and operation of the first to fourth process cartridges Sa, Sb, Sc and Sd are substantially the same except for the color of the image to be formed. Hence except in a case requiring distinction, the process cartridges will be described generally, and the subscripts a, b, c and d added to the reference signs, to indicate the color for which the element is used, are omitted.

In this embodiment, the image forming apparatus 100 includes a plurality of image bearing members, which are four drum type electrophotographic photosensitive members, that is, photosensitive drums 1 (1a, 1b, 1c, 1d) which are disposed side-by-side in the direction crossing the vertical direction. The photosensitive drum 1 is rotary-driven by a driving source 550. Around the photosensitive drum 1, a charging roller 2 (2a, 2b, 2c, 2d), a scanner unit (exposing apparatus) 3 (3a, 3b, 3c, 3d), which is exposing unit, and a developing unit (developing apparatus) 4 (4a, 4b, 4c, 4d) are disposed. The charging roller 2 is charging unit for uniformly charging the surface of the photosensitive drum 1.

The scanner unit 3 is exposing unit for forming an electrostatic image (electrostatic latent image) on the photosensitive drum 1 by radiating a laser based on output which the CPU computed from image information inputted by the host computer 199 (e.g. personal computer). When the electrostatic latent image, in accordance with the image signal, is formed by the exposing unit, a non-image area on the surface of the photosensitive drum 1 is uniformly exposed at weaker intensity, so as to stabilize the photosensitive drum potential. In the following, distinction is made between exposure (first exposure) which forms an electrostatic image using the exposing unit, and weak exposure (second exposure) which uniformly exposes the non-image area. The developing unit 4 is developing unit for developing an electrostatic image into a developer (hereafter toner) image. The photosensitive drum 1 is integrated with the charging roller 2 and the developing unit 4 which are processing unit acting on the photosensitive drum 1, and a process cartridge S is formed thereby. The process cartridge S is detachably attached to the image forming apparatus 100 via attaching unit, (e.g. attaching guide, positioning member) disposed in the image forming apparatus 100.

Facing the plurality of (four in this example) photosensitive drums 1, an intermediate transfer belt 10, to transfer the toner image on each photosensitive drum 1 onto a recording material P, is disposed. The intermediate transfer belt 10 is a transferred member onto which the toner image is transferred. In this embodiment, using an intermediate transfer system, the intermediate transfer belt 10 is an intermediate transfer member. Instead of the intermediate transfer member, a recording material conveying member to convey a recording medium may be used, and in a case of using a monochrome printer as the image forming apparatus 100, a recording medium, instead of the intermediate transfer member, may be used as the transferred member. The intermediate transfer belt 10, which is an endless belt, contacts all the photosensitive drums 1, and circularly moves (rotates) in the arrow R3 direction in FIG. 2 (clockwise). The intermediate transfer belt 10 passes around a plurality of support members (a driving roller 11, a stretching roller 12 and a secondary transfer opposing roller 13). The intermediate transfer belt 10 rotates by the driving roller 11 rotating in a direction R2.

On the inner peripheral surface side of the intermediate transfer belt 10, four primary transfer rollers 14 (14a, 14b, 14c, 14d) are disposed as primary transfer unit, so as to face each photosensitive drum 1 respectively. The primary transfer roller 14 presses the intermediate transfer belt 10 toward the photosensitive drum 1, so as to form a primary transfer portion where the intermediate transfer belt 10 and the photosensitive drum 1 contact. To the primary transfer roller 14, voltage having a reverse polarity of the normal charging polarity of the toner is applied (Vtr=+100V is applied in this embodiment) from a primary transfer power supply 15 (high voltage power supply) which is primary transfer voltage applying unit. Thereby a toner image on the photosensitive drum 1 is primary-transferred onto the intermediate transfer belt 10. In a case of forming a full color image, this process is sequentially performed in the first to fourth process cartridges Sa, Sb, Sc and Sd, and each color of toner image is superimposed on the intermediate transfer belt 10, and the superimposed toner image is primary-transferred.

The primary transfer roller 14 is a Φ6 mm cylindrical metal roller made of nickel plated SUM material.

The intermediate transfer belt 10 is an endless belt made of conductive material generated by adding a conductive agent to a resin material, and the base layer thereof is an endless polyimide resin of which periphery is 700 mm and thickness is 70 μm, in which carbon is mixed as the conductive agent. The electric characteristic exhibits an electronic conductivity, and is characterized by small fluctuations in resistance with respect to temperature and humidity in the atmosphere. In this embodiment, the volume resistivity of the intermediate transfer belt 10 is 1×10⁹ Ω·cm. The volume resistivity is measured by HIRESTA-UP (MCP-HT450) made by Mitsubishi Chemical Corp., using a ring probe type UR (MCP-HTP12). The measurement conditions are set to: room temperature 23° C., room humidity 50%, applied voltage 100V, and measuring time 10 sec. The volume resistivity here is a scale of conductivity of the material of the intermediate transfer belt 10.

On the outer peripheral surface side of the intermediate transfer belt 10, a secondary transfer roller 20 (secondary transfer unit) is disposed at a position facing the secondary transfer opposing roller 13. The secondary transfer roller 20 press-contacts with the secondary transfer opposing roller 13 via the intermediate transfer belt 10, so as to form a secondary transfer portion where the intermediate transfer belt 10 and the secondary transfer roller 20 contact. To the secondary transfer roller 20, voltage having a reverse polarity of the normal charging polarity of the toner is applied from the secondary transfer power supply 21 (high voltage power supply) which is secondary transfer voltage applying unit. Thereby a four-color toner image on the intermediate transfer belt 10 is secondary-transferred together onto the recording material P by the function of the secondary transfer roller 20, which contacts with the intermediate transfer belt 10 via the recording material P. The recording material P stored in the cassette 51 is conveyed to the secondary transfer portion by the feeding unit 50, synchronizing with the movement of the intermediate transfer belt 10.

On the secondary transfer opposing roller 13, an intermediate transfer belt cleaning apparatus 16 is contacted via the intermediate transfer belt 10, whereby secondary transfer residual toner, remaining on the intermediate transfer belt 10, is cleaned and removed, and is stored in a waste toner container 17.

The recording material P, which carries a four-color toner image after finishing the second transfer, is conveyed to a fixing apparatus 30, that is, a fixing nip portion formed by a fixing roller 31 and a pressure roller 32. The recording material P is heated and pressed there whereby the four-color toner images are melted and mixed, and fixed onto the recording material P, then the recording material P is discharged from the image forming apparatus 100.

The image forming apparatus 100 may form a single color or multicolor image using only one desired image forming unit, or a plurality of (not all) image forming units.

In this embodiment, the image forming apparatus 100 is a printer which has a process speed of 148 mm/sec., and which supports A4 size paper.

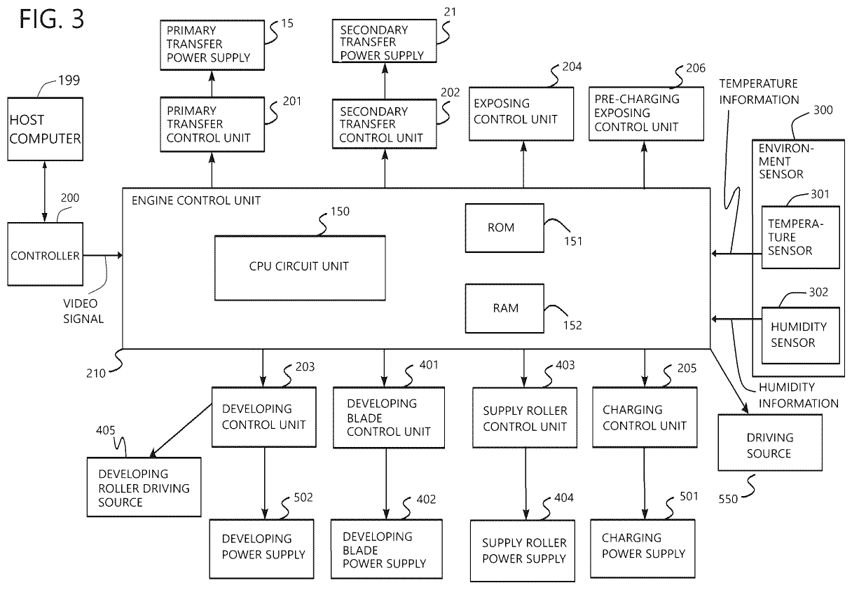

A configuration of an engine control unit 210, to control this image forming apparatus in general, will be described with reference to FIG. 3. The engine control unit 210 (control unit) includes a CPU circuit unit 150, a ROM 151 and a RAM 152, as indicated in FIG. 3. The CPU circuit unit 150 comprehensively controls a primary transfer control unit 201, a secondary transfer control unit 202, a developing control unit 203, an exposing control unit 204, a charging control unit 205, a pre-charging exposing control unit 206, a developing blade control unit 401 and a supply roller control unit 403, in accordance with a control program stored in the ROM 151. The RAM 152 temporarily stores control data, and is also used as a work area for arithmetic processing required for control. When the controller 200 receives print information and print instructions from the host computer 199, the controller 200 sends this data as video signals which the engine control unit 210 can process. The engine control unit 210 executes image forming operations required for printing by controlling each component (primary transfer control unit 201, secondary transfer control unit 202, developing control unit 203, exposing control unit 204, charging control unit 205, pre-charging exposing control unit 206, developing blade control unit 401, supply roller control unit 403, driving source 550). An environment sensor 300 is a sensor to acquire environment information around the apparatus, and includes a temperature sensor 301 to detect temperature information, and a humidity sensor 302 to detect humidity information.

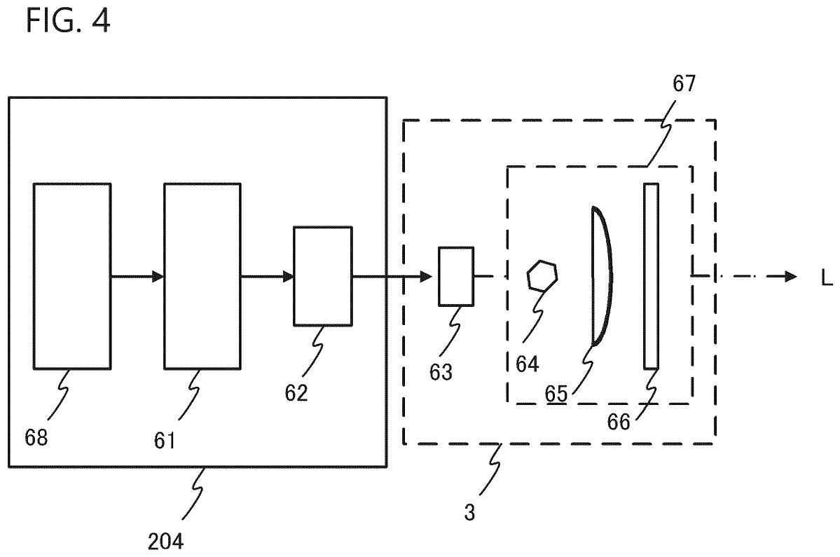

Control of weak exposure in the non-image area performed in this embodiment will be described with reference to FIG. 4. In FIG. 4, the image signal sent from the controller 200 is a multi-value signal (0 to 255) having 8-bits=256 gradation in the depth direction, and when this signal is 0, the laser beam is off, when this signal is 255, the laser beam is fully on, and when this signal has a value between 1 to 254, the laser beam has an intermediate value between these two values. Here the non-image area exposing level can be freely set using the level of this multi-value signal. In the following description, the non-image area exposure is performed setting 32 as the level of the multi-value signal. In a non-image area, where an image signal sent from the controller 200 has a value of 0, the image is converted into an image having a value of 32 by an image signal converting circuit 68 in the exposing control unit 204, and an image signal having a value in the 1 to 255 range is compressed and converted into an image having a value in the 33 to 255 range. Then the signals are converted into signals in a serial time axis direction by a frequency modulating circuit 61, and in this example, the signals are used for pulse width modulation of each dot pulse of which resolution is 600 dots/inch.

By this signal, a laser driver 62 is driven, a laser diode 63 emits light, and the laser beam L is emitted thereby. This laser beam L is radiated to the photosensitive drum 1 as a scanning light, by way of a correction optical system 67 which includes a polygon mirror 64, a lens 65, and a return mirror 66. The frequency modulating circuit 61 may be disposed on the controller side, separate from the laser driver 62.

When the scanner unit 3 (exposing apparatus) performs weak exposure, a predetermined area is exposed by repeating main scanning in a main scanning direction and sub-scanning in a sub-scanning direction on the surface of the photosensitive drum 1. The main scanning direction is a direction along the rotating shaft direction of the photosensitive drum 1. By the scanner unit 3 performing the main scanning, one line in the main scanning direction can be weakly exposed. In other words, one line is weakly exposed each time the main scanning is performed. The sub-scanning direction is a circumferential direction of the surface of the photosensitive drum 1, which crosses the main scanning direction. The scanner unit 3 can move the exposing position between lines by the sub-scanning.

### Description on Process Cartridge

General configuration of a process cartridge S which is attached to the image forming apparatus 100 of this embodiment will be described next. The process cartridge S is configured by integrating a photo-receptor unit, which includes the photosensitive drum 1 and the rotatable charging roller 2, and a developing unit (developing apparatus) 4, which includes the rotatable developing roller 22 and the like.

The photosensitive drum 1 is rotatably supported by a bearing. The photosensitive drum 1 is configured to be rotary-driven in the arrow R1 direction (counterclockwise) in FIG. 2 in accordance with the image forming operation by the driving force of the driving source 550 that is being transferred to the photo sensitive unit. The charging roller 2 is configured to be rotated by following the photosensitive drum 1 with a roller portion made of a conductive rubber press-contacting the photosensitive drum 1. In this embodiment, the charging roller 2 press-contacts the photosensitive drum 1, but the present disclosure is not limited to this, and a non-contact charging type, such as a corona charger, may be used. In the rotating direction R1 of the photosensitive drum 1, the charging roller 2, the scanner unit 3, the developing roller 22, and the primary transfer roller 14 are disposed in this sequence from the upstream side, in order from the charging roller 2.

The photosensitive drum 1 is a φ20 mm aluminum element pipe on which a photosensitive layer and a surface layer are formed, and a thin film layer formed of polyacrylates, of which film thickness is 23 μm, is used.

The charging roller 2, which is a 5.5 mm diameter metal shaft on which an elastic layer formed of a conductive rubber (volume specific resistivity is about 1×10⁶ Ωcm) is disposed to be a 1.5 mm thickness, and a length of the charging roller 2 is 228 mm, and the diameter thereof is φ8.5 mm. The charging roller 2 is press-contacted with the photosensitive drum 1 at 300 gf applied from each bearing (not illustrated) disposed at each end of the metal shaft (that is, at 600 gf in total). Thus the charging roller 2 rotates following the rotation of the photosensitive drum 1 while forming about a 300 μm wide nip.

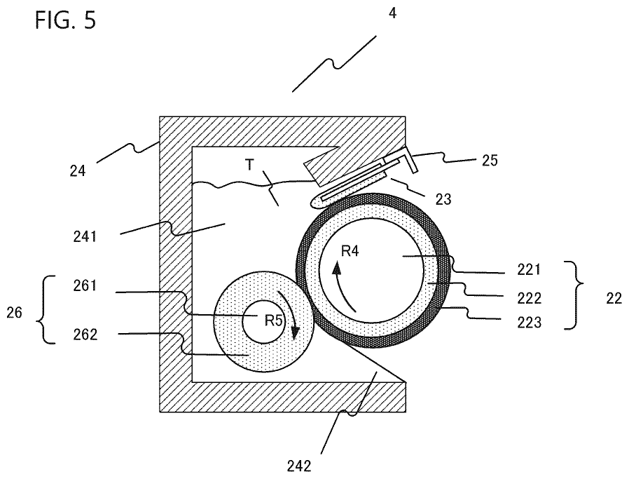

As illustrated in FIG. 5, the developing unit 4, on the other hand, includes a developing roller 22 which carries toner T, a developing blade 23 (regulating member), and a developing frame 24 which secures these elements. The developing frame 24 includes a developing chamber 241 (developer container) in which the developing roller 22 is disposed, and a blow out preventing sheet 242 which seals a developing opening (opening portion) by which the developing chamber 241 opens to the outside. One end of the developing blade 23 is fixed to a fixing member 25, which is fixed to the developing frame 24, and the other hand of the developing blade 23 is in contact with the developing roller 22, so that the toner coating amount on the developing roller 22 can be regulated, and charges can be provided to the developing roller 22. The developing roller 22 is disposed at the developing opening portion, and can contact with the photosensitive drum 1.

As illustrated in FIG. 5, the developing roller 22 used here is a φ10 mm roller. This roller has a 6.0 mm diameter metal core 221 on which a base layer 222 formed of conductive silicon rubber (volume specific resistivity is about 1×10⁷ Ωcm) and a surface layer 223 formed of urethane are sequentially layered to be a 2.0 mm thickness. The developing roller 22 is disposed to be rotary-driven in the arrow R4 direction in FIG. 5. The developing roller 22 rotates at a different speed from the photosensitive drum 1, in order to control the developing amount of toner onto the photosensitive drum 1. In this embodiment, the developing control unit 203 indicated in FIG. 3 controls a developing roller driving source 405, and the rotating speed of the developing roller 22, with respect to the rotating speed of the photosensitive drum 1, can be changed by controlling the developing roller driving source 405. In this embodiment, the developing roller 22 rotates at a 140% speed with respect to the rotation of the photosensitive drum 1. The developing roller driving source 405 is a driving member (e.g. motor). Here the developing roller driving source 405 is an independent motor. However the driving source 550 used for driving the photosensitive drum 1 and the charging roller 2 may be shared as the developing roller driving source 405.

As illustrated in FIG. 5, the developing blade 23 contacts the developing roller 22 in the counter direction with respect to the rotating direction of the developing roller 22, so as to regulate the coating amount of the toner and provide charges by triboelectric charging. In this embodiment, a leaf spring type SUS plate support member (not illustrated) of which thickness is 50 to 120 μm is used as the developing blade 23 (toner regulating blade), and the surface of the blade portion is contacted with the developing roller 22 using the spring elasticity of this support member. The blade portion is configured such that the blade portion is disposed at one end in the shorter direction, and the other end is fixed to and supported by the developing frame 24. The blade portion used here is a support member on which surface a conductive urethane resin thin film is coated. The coating amount of toner and charging amount of toner are controlled by applying a predetermined DC voltage to the developing blade 23 (developing blade voltage Vbld, Vbld=−500V during the image forming operation of this embodiment), and controlling the potential difference between the developing blade voltage Vbld and voltage applied to the developing roller 22 (developing roller potential Vdc, Vdc=−300V during the image forming operation of this embodiment), that is, controlling the developing blade contrast ΔVbld=Vbld−Vdc (ΔVbld=−200V during the image forming operation of this embodiment).

A supply roller 26 is a φ5.5 (mm) outer diameter core metal electrode 261 (conductive support member) around which a foamed urethane layer 262 is disposed. The outer diameter of the supply roller 26, including the foamed urethane layer 262, is φ11 (mm). A penetration level of the supply roller 26 and the developing roller 22 is 1.2 mm. If the state where the supply roller 26 and the developing roller 22 are in contact at one point on the outer periphery is a reference state, the surface layer of the supply roller 26 or the developing roller 22 deforms as the supply roller 26 and the developing roller 22 moves toward each other, and one penetrates the other. The “penetration level” mentioned above is an amount of penetration from the reference state. The supply roller 26 rotates in such a direction with which the supply roller 26 and the developing roller 22 have speeds in opposite directions at the contact portion with the developing roller 22 (arrow R5 direction in FIG. 5). The powder pressure of toner T that exists around the foamed urethane layer 262 acts on the foamed urethane layer 262, and the toner T is taken into the foamed urethane layer 262 by rotating the supply roller 26.

The supply roller 26 containing toner T supplies toner T to the developing roller 22 at the contact portion with the developing roller 22, and provides preliminary triboelectric charges to the toner T by rubbing. The supply roller 26, which supplies toner to the developing roller 22, also has a role to strip toner remaining on the developing roller 22 without being developed by the developing unit.

The toner supply amount and the preliminary triboelectric charge amount are controlled by applying a predetermined DC voltage to the supply roller 26 (supply roller voltage Vrs, Vrs=−500V during the image forming operation of this embodiment), and controlling the potential difference between the supply roller voltage Vrs and voltage applied to the developing roller 22 (developing roller potential Vdc, Vdc=−300V during the image forming operation of this embodiment), that is, controlling the supply roller contrast ΔVrs=Vrs−Vdc (ΔVrs=−200V during the image forming operation of this embodiment).

The toner T is a non-magnetic toner of which normal charging polarity is negative, produced by the suspension polymerization method. The volume-average particle diameter of the toner T is 7.0 μm, and the toner T carried on the developing roller 22 is charged to negative polarity. To improve the surface quality of the base of the toner T (carbon-based composition, such as binder resin and a release agent contained in toner particles), an external additive, that is, silicon oxide particles (about 1.5% with respect to the weight of toner) is adhered (externally added) to the surface of the toner, and the volume-average particle diameter of the silicon oxide particles is about 20 to 120 nm.

When toner T is rubbed by the developing blade 23 for a long period of time, the particle shape of the toner may become deformed, or the additive on the surface of the toner may peel off or become embedded. If the particle shape of the toner changes, the contact area between the toner T and the photosensitive drum 1 increases. If the external additive on the toner surface peels off, the resin component of the toner and the photosensitive drum 1 contact, and if the external additive is embedded in the toner, the contact area between the toner and the photosensitive drum 1 increases. As a result, the non-electrostatic adhesive force with the photosensitive drum 1 increases compared with the new product state, and this is called the “deterioration of toner” in this embodiment. The change of the non-electrostatic adhesive force caused by the change in the particle shape of the toner can be expressed by a change of the average circularity (aspect ratio) of the toner. In this embodiment, the average circularity of toner in the new product state is about 0.95, and a state where the average circularity becomes 0.90 or less is regarded as a deteriorated state. The average circularity of toner can be measured under the measurement/analysis conditions of a calibration operation, using the flow type particle image analyzing apparatus “FPIA-3000” (made by Sysmex Corp.).

The change of the surface state caused by peeling or embedding of the external additive contained in toner T can be quantitatively understood using a BET value. In this embodiment, the BET value of the toner is measured by QUADRA.SORB SI made by Quantachrome Co. The BET value of the toner used to observe the change of the adhering state of an external additive to the surface of toner indicates the adhesion amount of the external additive on the toner surface, and the BET value of toner decreases as the amount of the external additive that exists on the toner surface decreases. In other words, if an external additive having a high BET value is externally added to the surface of the toner base, the BET value of the toner itself also increases, but the BET value of the toner actually decreases due to the embedding of the external additive into the toner resin, and to the separation of the external additive from the toner surface. If the external additive is completely removed from the toner surface, the BET value of the toner becomes the same as the BET value of the toner base. In this embodiment, the BET value in the new product state is about 2.8 m²/g, and the state where the BET value is 2.0 m²/g or less is regarded as the deteriorated state.

The change of the non-electrostatic adhesive force can be expressed by other indices, and for example, the amount of toner remaining after the primary transfer (primary transfer residual toner) can be directly measured, and the change of the non-electrostatic adhesive force can be determined based on the increase of the primary transfer residual toner.

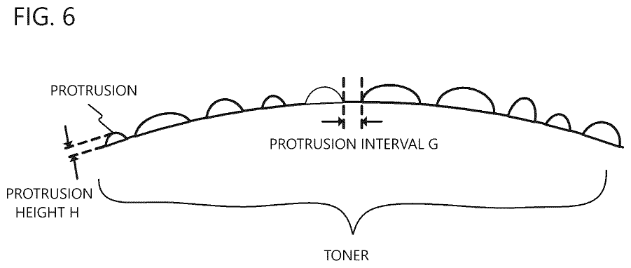

In this embodiment, toner generated by adding an external additive to the toner base body is used as toner T, but the present disclosure is not limited to this, and toner having protrusions, as indicated in FIG. 6, containing organic silicon polymer having a partial structure expressed by the following formula (1), on the surface of the toner base body, may be used.

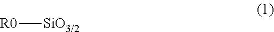

(R0 is an alkyl group or phenyl group having 1 or more and 6 or less carbon atoms)

The interval G of the protrusions and the height H of the protrusions on the surface of the toner illustrated in FIG. 6 can be measured by a scanning probe microscope (SPM). The SPM includes a probe, a cantilever which supports the probe, and a displacement measuring system which detects the curvature of the cantilever. The SPM detects an interatomic force (attractive force or repulsive force) between the probe and a specimen, whereby the surface shape of the specimen is observed.

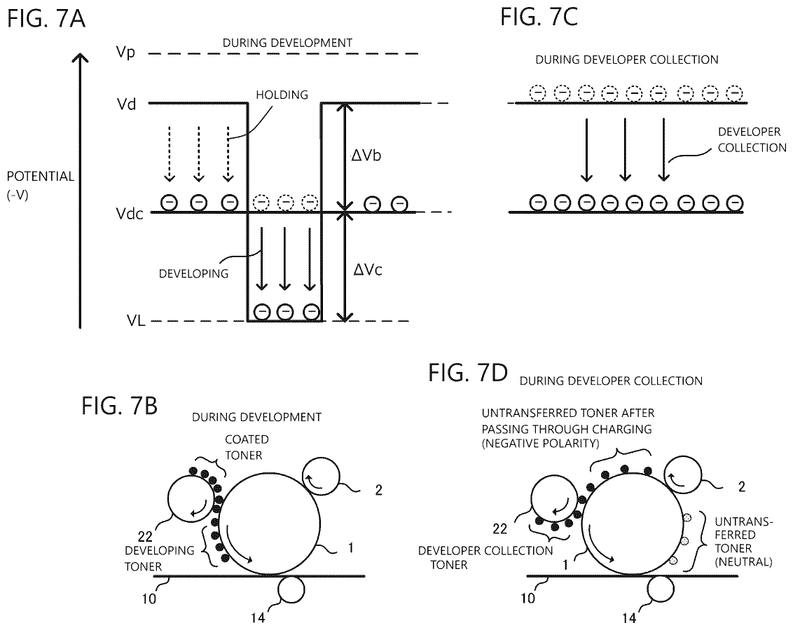

In the above configuration, development of toner and collection of untransferred toner in the developing unit will be described with reference to FIGS. 7A to 7D. A solid line circle in FIGS. 7A to 7D indicates toner after moving, and a broken line circle indicate toner before moving.

Development of toner will be described first with reference to FIGS. 7A and 7B. FIG. 7A is a schematic diagram depicting a potential relationship when the toner is developed. In FIG. 7A, Vp indicates “Drum Potential Vp After Charging”. Vd indicates “Drum Potential Vd After Weak Exposure”. Vdc indicates “Developing Voltage Vdc”. VL indicates “Exposing Unit Potential VL”. ΔVb indicates “Back Contrast ΔVb”. ΔVc indicates “Developing Contrast ΔVc”. FIG. 7B is a schematic diagram depicting an area around the developing unit when toner is developed. The voltage Vpri that is applied to the charging roller 2 (hereafter “charging voltage”) during image formation according to this embodiment is −1200V, and the drum potential Vp after charging is approximately −700V. The drum potential Vd after weak exposure, which is formed in the non-image area by weak exposure light is approximately −480V. The developing voltage Vdc applied to the developing roller 22 is −300V, and the drum potential VL of the exposing unit where charges were attenuated by exposure is approximately −150V. Primary transfer is performed using the potential difference ΔVtr1 between the drum potential VL in the exposing unit and the primary transfer voltage Vtr.

As illustrated in FIGS. 7A and 7B, the negatively charged toner contacts the photosensitive drum 1 in the developing unit, and the electrostatic latent image is visualized due to the potential difference between the developing roller potential Vdc and the drum potential VL in the exposing unit (hereafter called “developing contrast ΔVc”), whereby a toner image is formed. By the potential difference between the developing voltage Vdc and the drum potential Vd after weak exposure formed by weak exposing light (hereafter called “back contrast ΔVb”), toner on the developing roller 22 is electrically held without being transferred to the non-image area.

A method for processing toner remaining on the surface of the photosensitive drum 1 without being transferred to the intermediate transfer belt 10 (hereafter called “untransferred toner”) in the primary transfer step will be described next. In this embodiment, the untransferred toner is collected by the developing roller 22 and is reused. The method for collecting the untransferred toner by the developing roller 22 (hereafter called “developer collection”) will be described with reference to FIGS. 7C and 7D.

FIG. 7C is a schematic diagram depicting a potential relationship during the developer collection, and FIG. 7D is a schematic diagram depicting an area around the developing unit during the developer collection. Toner which has low charging amount and almost neutral polarity, out of the toner developed on the photosensitive drum 1, remains on the surface of the photosensitive drum 1 as untransferred toner, without being transferred to the intermediate transfer belt 10 in the primary transfer step. As illustrated in FIGS. 7C and 7D, the untransferred toner is charged to normal charging polarity by the charging voltage Vpri while passing through the charging roller 2. At the same time, the drum potential Vp after charging is formed on the surface of the photosensitive drum 1 by the charging voltage Vpri, and then the drum potential Vd after weak exposure is formed by weak exposure. The untransferred toner (charged to normal charging polarity) on the drum surface on which the drum potential Vd after weak exposure is formed and collected by the developing roller 22 using an electric field generated by the potential difference ΔVb between the potential Vdc of the developing roller 22 (formed by DC voltage applied to the developing roller 22) and the drum potential Vd after weak exposure, and is reused.

To explain the features of Embodiment 1, steps of developer collection processing of the residual toner formed on the photosensitive drum will be described.

Residual Toner Formed on Photosensitive Drum when Image Forming Operation is Interrupted

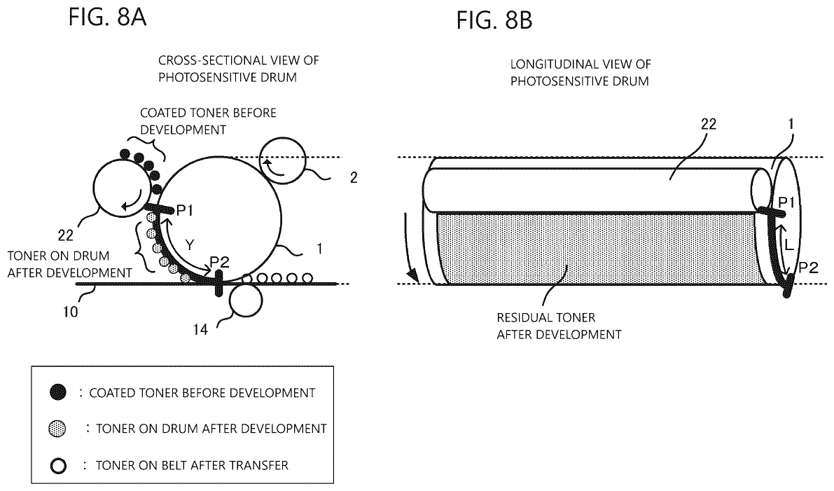

In some cases where the image forming operation is interrupted during printing, such as when a paper jam is detected, a toner image may be formed and remain on the photosensitive drum 1. FIG. 8A is a cross-sectional view of the photosensitive drum 1, and FIG. 8B is a longitudinal view of the photosensitive drum 1 after the image forming operation is interrupted. Toner coated on the developing roller 22 is called “coated toner before development”, and is indicated by black circles. A portion where the developing roller 22 and the photosensitive drum 1 face is defined as P1 (development facing portion), and a portion where the photosensitive drum 1 and the intermediate transfer belt 10 face is defined as P2 (transfer facing portion), and the distance between P1 and P2 on the circumference is regarded as Y. In Embodiment 1, Y is about 18 mm. The toner image formed between P1 and P2 is called “toner on the drum after development”, and is indicated by dotted circles. The residual toner on the surface of the photosensitive drum is returned to the developing roller 22, and the surface of the photosensitive drum 1 is cleaned. The toner transferred to the intermediate transfer belt 10 immediately before the interruption of the image forming operation is called “toner on the belt after transfer”, and is indicated by white circles. This toner is collected by the waste toner container 17, which is cleaning unit for the intermediate transfer belt 10.

### Developer Collection of Residual Toner Formed on Photosensitive Drum

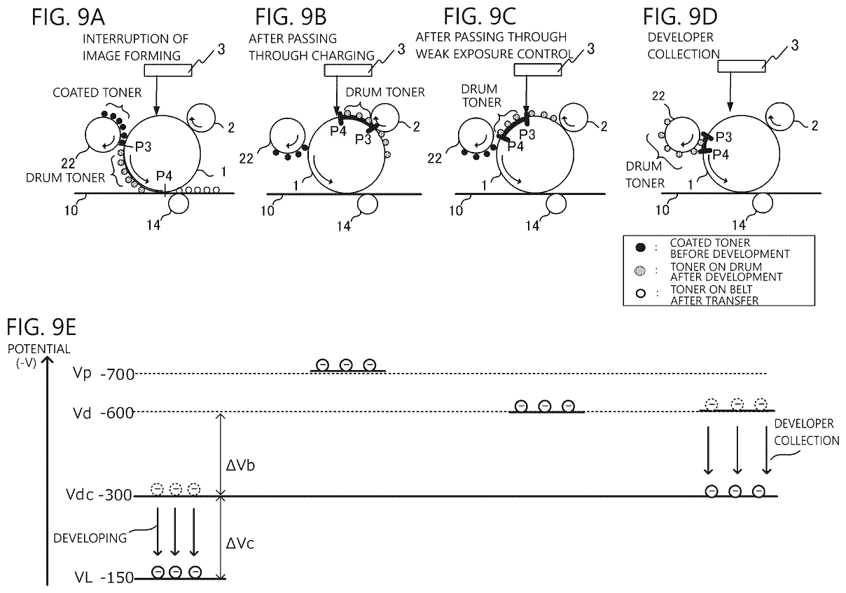

On the upper portion of FIGS. 9A to 9E, four steps of developer collection, to return the residual toner formed on the photosensitive drum 1 (toner on drum after development) back to the developing roller 22, are illustrated (FIGS. 9A to 9D). The lower part of FIGS. 9A to 9E indicates surface potential and developing voltage of the photosensitive drum 1 in each step (FIG. 9E). The surface potential here refers to potential on the surface of the photosensitive drum 1 between P3 and P4 in FIGS. 9A to 9E. Here, In FIG. 9E, Vp indicates “Drum Potential Vp After Charging”. Vd indicates “Drum Potential Vd After Weak Exposure”. Vdc indicates “Developing Voltage Vdc”. VL indicates “Exposing Unit Potential VL”. ΔVb indicates “Back Contrast ΔVb”. ΔVc indicates “Developing Contrast ΔVc”.

Each step will be described. FIG. 9A indicates a state immediately after the image forming operation is interrupted. FIG. 9B indicates a state where the driving source 550 of photosensitive drum 1 etc. is restarted from interruption of image forming operation, and the residual toner on the photosensitive drum 1 is passing through the charging unit 2. FIG. 9C indicates a state where the exposing unit 3 exposes (emits light to) the surface of the photosensitive drum 1 charged by the charging unit. FIG. 9D indicates a state where the residual toner is collected by the developing roller 22.

In FIGS. 9A to 9D, “drum toner” means “toner on the drum”. In other words, “drum toner” means: “toner on drum after development” in FIG. 9A, “toner on drum after development (after passing through charging)” in FIG. 9B, “toner on drum after development (after passing through weak exposure control)” in FIG. 9C, and “toner on drum after development (after developer collection)” in FIG. 9D.

At the timing of FIG. 9A, the exposing unit 3 forms an electrostatic latent image on the photosensitive drum 1, and toner on the developing roller 22 moves onto the photosensitive drum 1. In the electrostatic latent image forming unit between P3 and P4, the photosensitive drum potential is in the state of the potential VL of the exposure unit (−150V). At the timing of FIG. 9B, the toner passes through the charging unit 2 where a −1200V charging voltage is applied, hence the photosensitive drum potential between P3 and P4 is in the state of drum potential Vp after charging (−700V). At the timing of FIG. 9C, the exposing unit 3 performs weak exposure control of radiating the laser beam onto the photosensitive drum 1. The photosensitive drum potential between P3 and P4 is in the state of drum potential Vd after weak exposure (−600V). At the timing of FIG. 9D, the back contrast ΔVb, which is the potential difference between the developing voltage (−300V) and the drum potential Vd after weak exposure (−600V), is 300V. Most of the residual toner particles have minus charges. When these toner particles pass through the space between the developing roller 22 and the photosensitive drum 1, unnecessary toner particles having minus charges are attracted to the side of the developing roller 22 which has relatively plus potential. Thereby the residual toner can be collected in the developer container 241.

### Pixel Information Detection

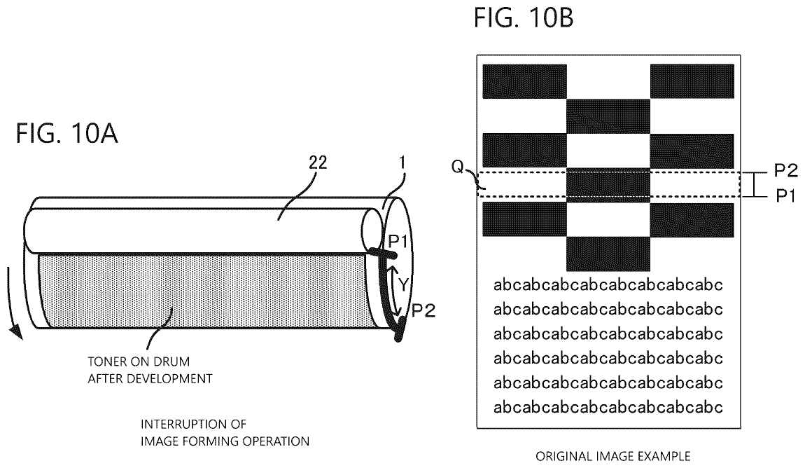

FIG. 10A is a longitudinal view of the photosensitive drum 1 in a state where the image forming operation is interrupted (paused) due to paper jamming in the conveying unit, for example. The area where the residual toner exists between P1 and P2 after development is indicated by halftones (dot pattern). FIG. 10B indicates an example of an original image of which image forming operation is interrupted. The toner image was formed on the photosensitive drum 1d under the conditions of: A4 paper, 600 dpi and monochrome mode. The CPU 150 calculates the timing when the image forming operation was interrupted, and cross-checks the interrupt timing and the original image. Thereby a part of the original image, which is drawn on the photosensitive drum 1d between P1 and P2 immediately after the image forming operation is interrupted, can be calculated. This makes it possible to acquire the corresponding positions in FIG. 10B of P1 and P2 indicated in FIG. 10A. In FIG. 10B, an area between P1 and P2, enclosed by a dotted line, is defined as “area Q”. A toner image indicated in the area Q remains on the photosensitive drum 1d.

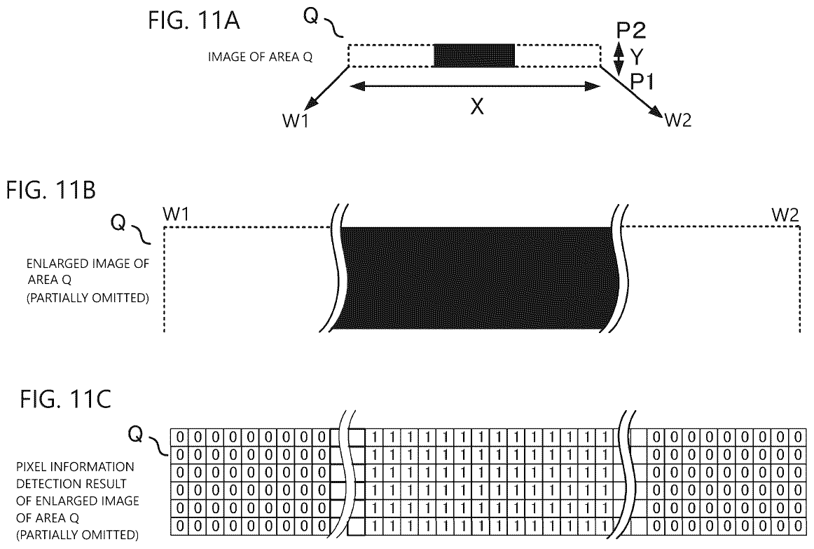

FIG. 11A indicates an original image in the area Q. The area Q is an area extracted from the A4 paper area. X (A4 paper width) is 210 mm, and Y (distance between P1 and P2) is 18 mm. In the case of 600 dpi, 4961 pixels in the X directions and 425 pixels in the Y direction are arrayed in the area Q. FIG. 11B is an enlarged view of the image of the area Q. Portions in the vertical direction and in the horizontal direction are partially omitted. W1 and W2 in FIGS. 11A and 11B are corresponding positions. FIG. 11C is the pixel information detection result calculated based on the image information on the area Q. Each pixel has density information, and the density information of each pixel is managed by 8-bit data (0 to 255). If this density information of a pixel is larger than 0, it is determined that the pixel has color (density), and is set to “1”. If this density information of a pixel is 0, it is determined that the pixel has no color (density), and is set to “0”. This result generated by converting the density information into “0” or “1” is called “pixel information detection result”. In this way, the engine control unit 210 functions as image information acquiring unit when information on the toner image is acquired.

### Pixel Information Detection Result and Weak Exposure Control

The photosensitive drum potential in the steps in FIGS. 9A to 9E will be described. In FIG. 9A, the photosensitive drum potential is VL (−150V). In FIG. 9B, the photosensitive drum potential is lowered to Vp (−700V) by the charging unit 2. In FIG. 9C, the exposing unit 3 radiates a laser beam onto the photosensitive drum 1, and changes the photosensitive drum potential to Vd (−600V). The laser beam radiating step performed by the exposing unit 3 is called “weak exposure control”.

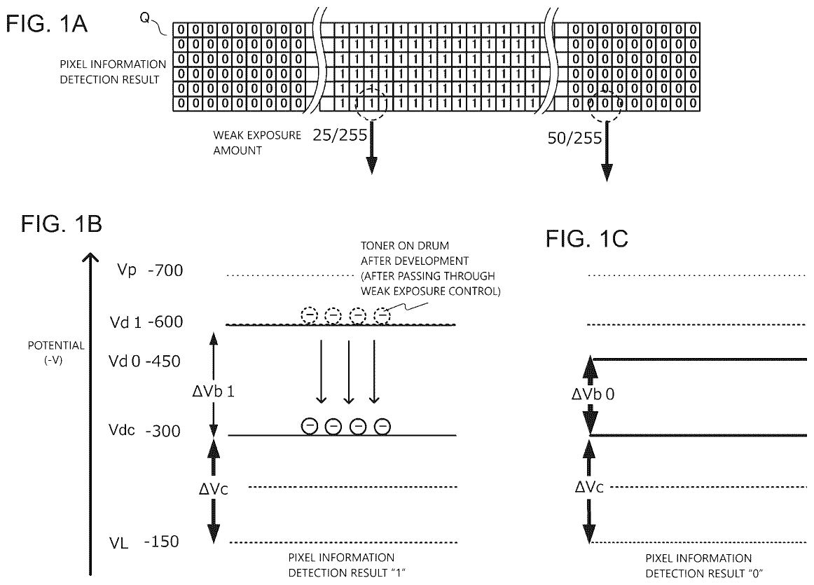

The relationship between the weak exposure control and the pixel information detection result will be described. FIG. 1A (upper part in FIG. 1) indicates the pixel information detection result in the area Q as a bit matrix. FIG. 1B (lower left side of FIG. 1) indicates the light quantity of the weak exposure and the relationship between the photosensitive drum potential and the developing voltage when the pixel information detection result is 1. In FIG. 1B, Vp indicates “Drum Potential Vp After Charging”. Vd1 indicates “Drum Potential Vd1 After Weak Exposure”. Vd0 indicates “Drum Potential Vd0 After Weak Exposure”. Vdc indicates “Developing Voltage Vdc”. VL indicates “Exposing Unit Potential VL”. ΔVb1 indicates “Back Contrast ΔVb1”. ΔVc indicates “Developing Contrast ΔVc”. FIG. 1C (lower right side of FIG. 1) indicates a light quantity of the weak exposure and the relationship between the photosensitive drum potential and the developing voltage when the pixel information detection result is 0. In FIG. 1C, ΔVb0 indicates “Back Contrast ΔVb0”. ΔVc indicates “Developing Contrast ΔVc”. The maximum output of the exposure amount of the exposing unit is expressed as 255/255, and the exposure output 0 of the exposing unit is expressed as 0/255. The weak exposure control refers to controlling the output of the exposing unit in the 0/255 to 60/255 range.

In FIG. 1B, when the pixel information detection result is “1”, the weak exposure amount is controlled to 25/255, and the drum potential Vd1 after weak exposure is controlled to −600V. Then the developing voltage is controlled to −300V. Thereby the back contrast ΔVb1 is controlled to a 300V potential difference. The residual toner after development has a minus charge, hence the residual toner can be returned to the developing roller 22 having a relatively plus potential.

In FIG. 1C, when the pixel information detection result is “0”, the weak exposure amount is controlled to 50/255, and the drum potential Vd0 after the weak exposure can be controlled to −450V. Thereby the back contrast ΔVb0 is controlled to a 150V potential difference. The absolute value of the photosensitive drum potential on the negative polarity side is small, hence movement of the toner having plus charges, coated on the developing roller, onto the photosensitive drum 1 can be prevented. In other words, movement of the reverse fogging toner onto the photosensitive drum 1 can be prevented.

In this embodiment, an area on the photosensitive drum 1 where developer collection can be performed is called “collected area”. The collected area has a predetermined range in a direction along the rotating shaft line of the photosensitive drum 1. The collected area is, for example, an area facing the developing roller 22 in the direction along the rotation shaft line of the photosensitive drum 1. In the collected area, a first area and a second area are set side-by-side in the direction along the rotation shaft line of the photosensitive drum 1. The first area is an area of which the pixel information detection result is “0”, that is, an area where toner does not exist. The second area is an area of which the pixel information detection result is “1”, that is, an area where toner exists and toner density is higher than the first area. Here the second back contrast (ΔVb1) of the second area is 300V, which is larger than the first back contrast (ΔVb0) of the first area (which is 150V).

As described above, it is a feature of Embodiment 1 that the light quantity of the weak exposure is adjusted based on the pixel information detection result. The light quantity of the weak exposure may be controlled for each detected pixel, or may be controlled for each light quantity control unit, including for a plurality of pixels. The light quantity control unit may be a predetermined size, and, for example, a square pixel group, or a group of a predetermined number of pixels in the scan direction during exposure, may be exposed by a common light quantity. In the case of adjusting the light quantity for each pixel, one pixel may be regarded as one light quantity control unit.

Verification of Effect of Weak Exposure Control Based on Pixel Information Detection Result

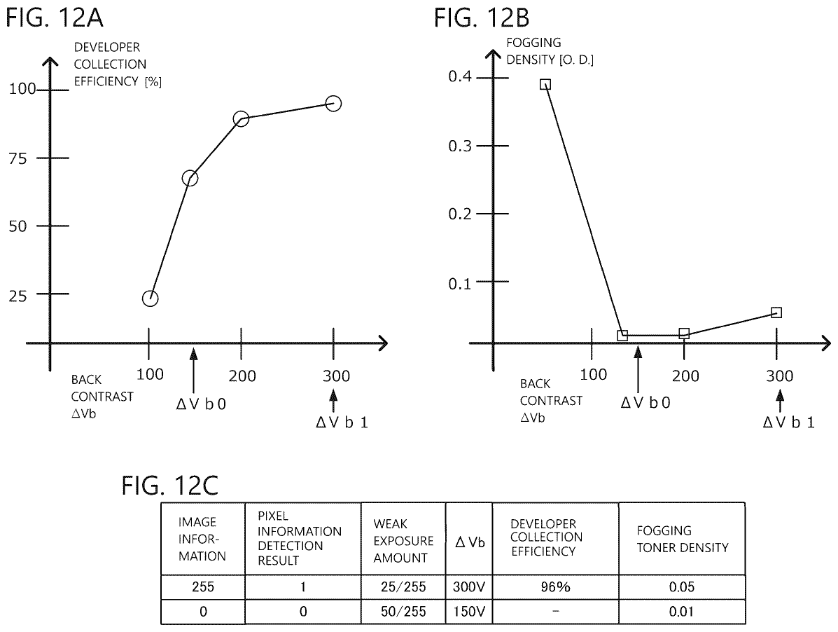

FIG. 12A indicates the back contrast ΔVb and collection efficiency (collection rate) of the residual toner after development by the developing roller 22. FIG. 12B indicates the density of fogging toner on the photosensitive drum 1 when the back contrast is controlled to ΔVb. FIG. 12C indicates the summary of the results in FIG. 12A and FIG. 12B.

Experiment conditions in FIG. 12A will be described. Here a Bk toner cartridge is used. First a toner image (maximum density: 255) is formed in the image forming area, then the image formation is paused during this image forming operation. When the operation is restarted after the pause, the light quantity of the weak exposure to the photosensitive drum 1 after passing the charging unit is adjusted, and change of the back contrast ΔVb is checked. Specifically, the back contrast ΔVb is adjusted, and the residual toner after development is collected by the developing roller 22. Then the residual toner amount on the photosensitive drum is measured, and collection efficiency by the developing roller 22 is calculated. According to FIG. 12A, the developer collection efficiency is higher as the back contrast ΔVb is larger. The back contrast ΔVb1 in an area of the photosensitive drum where residual toner exists is controlled to 300V. This means that the developer collection efficiency is close to 100%. The back contrast ΔVb0 in an area of the photosensitive drum where residual toner does not exist is controlled to 150V. Since no toner image for which developer is collected exist on the photosensitive drum, there is no problem to set a back contrast with which developer collection efficiency is low. In Embodiment 1, pixels having density information are controlled to have high back contrast, so that high developer collection efficiency is implemented in this pixel area.

Experiment conditions in FIG. 12B will be described. A Bk toner cartridge is used here as well. First imaging formation, in which density information is 0, is started, and the image formation is paused during this image forming operation. When operation is restarted after the pause, the light quantity of the weak exposure to the photosensitive drum 1 after passing the charging unit is adjusted, and the change of the back contrast ΔVb is checked. This time the density of fogging toner on the photosensitive drum is measured, after the surface of the photosensitive drum, that received the weak exposure, passed through the portion where the developing roller 22 and the photosensitive drum 1 face (developing facing portion P1). The fogging toner density is measured by a Macbeth densitometer (manufacturer: Gretag Macbeth). According to the graph in FIG. 12B, when the back contrast ΔVb is low (50V), the fogging density is high. When the back contrast ΔVb is high (300V) as well, the fogging density is high. If the back contrast ΔVb is controlled to around 120 to 200V, the fogging density is extremely low. In Embodiment 1, the back contrast ΔVb1 in an area on the drum where toner exist after development is controlled to 300V, and the back contrast ΔVb0 in an area where toner does not exist is controlled to 150V. In an area on the photosensitive drum where toner does not exist, the back contrast ΔVb0 is controlled to 150V, hence fogging toner is hardly generated on the photosensitive drum. In Embodiment 1, the back contrast can be controlled to be small for pixels which have no density information, so as to reduce fogging toner generated on the photosensitive drum. In this example, the fogging density is preferably less than 0.1.

The verification results will be summarized in FIG. 12C. The feature of Embodiment 1 is controlling the back contrast during developer collection based on the pixel information detection result of the residual toner formed on the photosensitive drum after development. The control amount of the weak exposure is different between the case where the pixel information detection result is “1” and the case where the result is “0”. The weak exposure amount is larger in the case of “0” than in the case of “1”. Thereby the back contrast ΔVb during developer collection can be controlled. In the case where the pixel information detection result is “1”, back contrast implementing high developer collection efficiency is required, so ΔVb1=300V is set, considering he balance with the fogging toner density. Here the developer collection efficiency is high (96%), and the fogging toner density is low (0.05).

In the case where the pixel information detection result is “0”, the developer collection is not required, hence the back contrast can be set to a value implementing a low fogging toner, that is, ΔVb0=150V. Here there is no data for the developer collection efficiency (because it cannot be measured), and the fogging oner density is very low (0.01).

If the back contrast ΔVb is controlled in the same way for all the areas of the photosensitive drum without using the image information, the fogging toner density in an area where no toner image exists becomes 0.05, instead of 0.01. It is the effect of the present disclosure that the fogging toner density becomes low.

Features of Embodiment 1 will be summarized. When the residual toner on the photosensitive drum after development is returned to the developing roller 22, the exposure amount to the photosensitive drum 1 by the exposing unit is controlled depending on whether or not a toner image exists on the photosensitive drum. Exposure amount is controlled to be small for an area where the residual toner image exists so that the developer recovery performance increases, and the exposure amount is controlled to be large for an area where the residual toner image does not exist so that the reverse fogging toner is reduced.

Thereby the residual toner image formed on the photosensitive drum when the image forming operation is interrupted, for example, can be collected by the developer container at high collection efficiency, and at the same time, the reverse fogging toner amount that moves onto the photosensitive drum 1 can be reduced. Since the reverse fogging toner decreases, it can be prevented that the charging unit is contaminated by the reverse fogging toner attached to the surface of the charging unit.

### Embodiment 2

In Embodiment 1, a method for controlling the back contrast ΔVb by distinguishing an area where residual toner after development exist and an area where the residual toner does not exist when the image forming operation is interrupted was described. In Embodiment 2, a method for controlling the back contrast ΔVb in accordance with the density of the residual toner after development when the image forming operation is interrupted will be described. In Embodiment 2, the developer collection efficiency can be further increased and the reverse fogging toner amount can be further reduced than in Embodiment 1. Embodiment 2 will be described below, focusing on the differences from Embodiment 1.

### Pixel Information Detection

Conditions and basic procedure of the pixel information detection are the same as Embodiment 1, hence description thereof will be omitted. The image information (density information) is managed by 8-bit data (0 to 255). The detection result is determined to be “2” if this image information (density information) is in a 1 to 128 range, the detection result is determined to be “1” if the image information is in a 129 to 255 range, and the detection result is determined to be “0” if the image information is 0. In Embodiment 2, the image information including color information is divided into two groups, and control suitable for each group is executed respectively. In Embodiment 2, image information of which density is at least 1 is divided into two groups, and a total of three types of detection results are acquired. However the number of groups may be increased.

### Pixel Information Detection Result and Weak Exposure Control

The feature of Embodiment 2 is that in the weak exposure control before the developer collection of residual toner after the development, the weak exposure amount is controlled based on the color information (density information) in the pixel information.

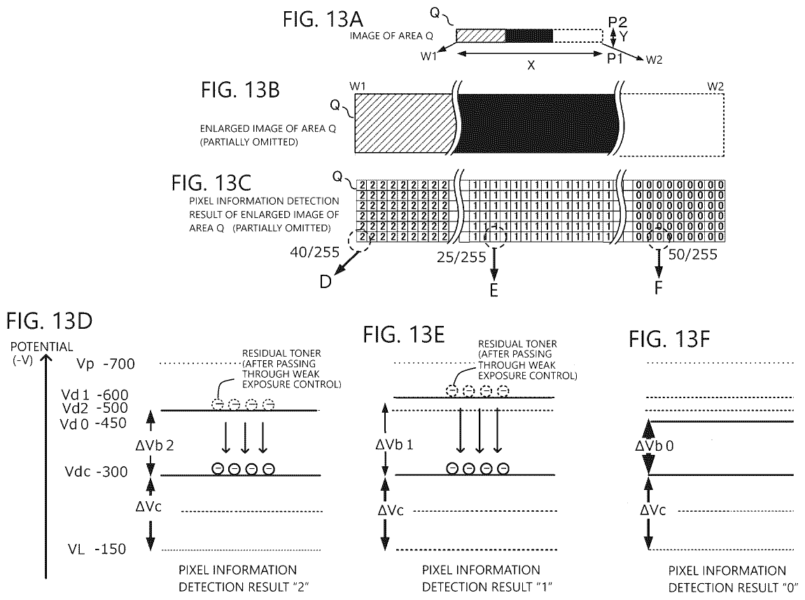

FIG. 13A indicates an image of an area Q where the residual toner after development exists. FIG. 13B indicates an enlarged view of this image. W1 and W2 in FIGS. 13A and 13B are corresponding positions. FIG. 13C indicates the pixel information detection result corresponding to the enlarged view. In the image of the area Q, the shaded portion indicates halftones where the density of Bk is 128. The black portion indicates the maximum density where the density of Bk is 255. The white portion indicates that there is no color information on Bk. According to the above mentioned rule of the pixel information detection, the image information (density information) of each pixel is classified into one of 2, 1 and 0.

FIGS. 13D to 13F) indicates the weak exposure amount and the relationship between the photosensitive drum potential and the developing voltage when the pixel information detection result is 2, 1 and 0. FIG. 13D is the case where the detection result is “2”, FIG. 13E is the case where the detection result is “1”, and FIG. 13F is the case where the detection result is “0”. In FIGS. 11D to 11F, Vp indicates “Drum Potential Vp After Charging”. Vd1 indicates “Drum Potential Vd1 After Weak Exposure”. Vd2 indicates “Drum Potential Vd2 After Weak Exposure”. Vd0 indicates “Drum Potential Vd0 After Weak Exposure”. Vdc indicates “Developing Voltage Vdc”. VL indicates “Exposing Unit Potential VL”. ΔVb0 indicates “Back Contrast ΔVb0”. ΔVb1 indicates “Back Contrast ΔVb1”. ΔVb2 indicates “Back Contrast ΔVb2”. ΔVc indicates “Developing Contrast ΔVc”.

In FIG. 13D, when the pixel information detection result is “2”, the weak exposure amount is controlled to 40/255, and the drum potential Vd2 after the weak exposure is controlled to −500V. The developing voltage is controlled to −300V. Thereby the back contrast ΔVb2 can be controlled to a 200V potential difference. In this area where the detection result is “2”, the density of the toner image formed on the photosensitive drum is relatively low (toner amount is less) compared with the area where the detection result is “1”, hence even if the back contrast ΔVb is low, the residual toner after development having minus charges can be returned to the developing roller 22 having a relative plus potential. Further, when the pixel information detection result is “2”, the potential difference of the back contrast ΔVb2 is small, and the absolute value of the photosensitive drum potential on the negative polarity side is small, hence the toner coated on the developing roller having plus charges hardly move to the photosensitive drum 1. In other words, the generation of reverse fogging toner on the photosensitive drum can be prevented.

In FIG. 13E, when the pixel information detection result is “1”, the weak exposure amount is controlled to 25/255, and the drum potential Vd1 after the weak exposure is controlled to −600V. The developing voltage is controlled to −300V. Thereby the back contrast ΔVb1 can be controlled to a 300V potential difference. The residual toner after development having minus charges can be returned to the developing roller 22 having a relative plus potential.

In FIG. 13F, when the pixel information detection result is “0”, the weak exposure amount is controlled to 50/255, and the drum potential Vd0 after the weak exposure is controlled to −450V. Thereby the back contrast ΔVb0 can be controlled to a 150V potential difference. The absolute value of the photosensitive drum potential on the negative polarity side is small, hence the toner coated on the developing roller having plus charges hardly moves to the photosensitive drum 1. In other words, the generation of reverse fogging toner on the photosensitive drum can be prevented.

As described above, the toner density becomes higher in the case where the pixel information detection result is 0, 2 and 1 in this order. Therefore it is controlled such that the weak exposure amount is increased and the absolute value of the back contrast ΔVb is increased in this order. In the case of increasing a number of divisions in the detection result as well, control is performed so that the back contrast becomes higher as the toner density in the area is higher.

### Verification of Effects of Weak Exposure Control Based on Pixel Information Detection Result

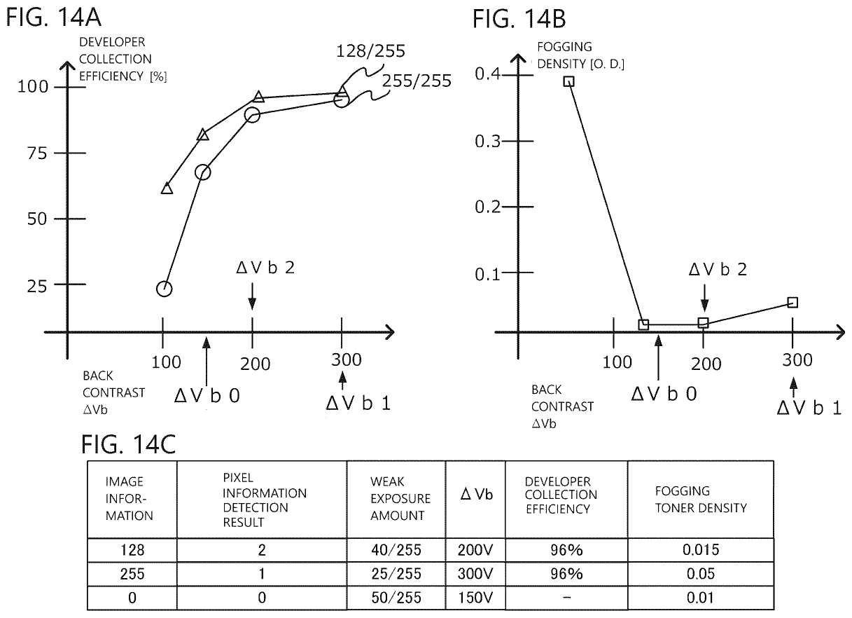

FIG. 14A indicates the back contrast ΔVb and collection efficiency (collection rate) of the residual toner after development by the developing roller 22. FIG. 14B indicates the density of fogging toner on the photosensitive drum when the back contrast is controlled to ΔVb. FIG. 14C indicates the summary of the result of FIG. 14A and FIG. 14B.

Experiment conditions in FIG. 14A will be described. A Bk toner cartridge is used here as well. Experiment is performed for two cases: a case of a toner image of which image information is 128 (halftones); and a case of a toner image of which image information is 255 (maximum density). First image formation to the photosensitive drum 1 is started at each density, then the image formation is paused during this image forming operation. When the operation is restarted, the light quantity of weak exposure to the photosensitive drum 1 after passing the charging mean is adjusted, and the change of the back contrast ΔVb is checked. Specifically, the back contrast ΔVb is adjusted, and residual toner after development is collected by the developing roller 22. Then the residual toner amount on the photosensitive drum is measured, and collection efficiency to the developing roller 22 is calculated. In FIG. 14A, the result of the developer collection efficiency when the image information is 128 (halftones) is indicated by white triangles, and the result of the developer collection efficiency when the image information is 255 (maximum density) is indicated by white circles. In both cases, the developer collection efficiency is higher as the back contrast ΔVb is higher. Even if the back contrast ΔVb is the same, the developer collection efficiency is higher in the image of which image information is 128 (halftones) than the image of which image information is 255 (maximum density). In other words, in the case of developer collection of a toner image of which density is low, a high developer collection efficiency can be implemented even if the back contrast ΔVb is low. This is because as the amount of toner on the photosensitive drum is higher, toner particles are superimposed on more layers, and are less easily returned to the developing roller 22. Therefore in a qualitative sense, the developer collection efficiency becomes higher as the amount of toner on the photosensitive drum is less.

FIG. 14B indicates the back contrast ΔVb and the fogging density. The experiment conditions and the white square plot are the same as FIG. 12B described in Embodiment 1, hence description thereof will be omitted here. As described in Embodiment 1, controlling the back contrast ΔVb in a 120 to 200V range is appropriate to prevent fogging toner.

In the case of a toner image of which density is low, the high developer collection efficiency can be implemented even if the back contrast ΔVb is low, hence ΔVb can be controlled to be low, about 200V. Thereby the fogging density indicated in FIG. 14B can be reduced.

The verification results will be summarized in FIG. 14C. In the case where density is low, as in the case where the image information is 128 (halftones), the pixel information detection result is “2”, and the weak exposure amount is set to 40/255, and the back contrast ΔVb is controlled to 200V. Here the developer collection efficiency is high (96%), and the fogging toner density is very low (0.01). When the toner density of the developer collection target is low, high back contrast is not required, hence prevention of fogging toner and high developer collection efficiency are both implemented. In the case where the image information is 255 (maximum density), the pixel information detection result is “1”, the weak exposure amount is set to 25/255, and the back contrast ΔVb is controlled to 300V. Here the developer collection efficiency is high (96%), and the fogging toner density is low (0.05). When the toner density of the developer collection target is high, high back contrast (300V) is required. In the case where image information does not exist, the pixel information detection result is “0”, the weak exposure amount is set to 50/255, and the back contrast ΔVb is set to 150V. Here there is no target toner image of the developer collection, and the fogging toner density is very low (0.01). Since the back contrast can be set to ΔVb which can easily prevent the generation of fogging toner, the fogging toner can be reduced to virtually zero.

In this verification, the developer collection efficiency is 96% in both cases of the back contrast 200V and 300V. In theory the developer collection efficiency should be lower in the case of the back contrast 200V than the case of 300V, and the reason for this may be as follows. As the back contrast is smaller, the developer collection efficiency is lower, but the fogging toner amount is less. In this verification, the toner amount on the photosensitive drum after passing through the developing roller was measured. The reason why the developer collection efficiency became the same under different back contrast conditions is probably because of the influence of the fogging toner amount.

In Embodiment 2, an area on the photosensitive drum 1 where developer collection is performed is regarded as “collected area”, and the same experiment as Embodiment 1 is performed. First the area where the pixel information detection result is “0” is regarded as “first area”, and the area where the pixel information detection result is “1” (toner density is higher) is regarded as “second area”. In this case, the first back contrast (ΔVb0) of the first area is 150V, and the second back contrast (ΔVb1) of the second area is 300V, that is, the second back contrast is higher than the first back contrast.

Next the area where the pixel information detection result is “2” is regarded as “first area”, and the area where the pixel information detection result is “1” (toner density is higher) is regarded as “second area”. In this case, the first back contrast (ΔVb2) of the first area is 200V, and the second back contrast (ΔVb1) of the second area is 300V, that is, the second back contrast is higher than the first back contrast.

Then the area where the pixel information detection result is “0” is regarded as “first area”, and the area where the pixel information detection result is “2” (toner density is higher) is regarded as “second area”. In this case, the first back contrast (ΔVb0) of the first area is 150V, and the second back contrast (ΔVb2) of the second area is 200V, that is, the second back contrast is higher than the first back contrast.

Features of Embodiment 2 will be summarized. When the residual toner on the photosensitive drum after development is returned to the developing roller, the exposure amount to the photosensitive drum 1 by the exposing unit is controlled using information on the density of the residual toner image on the photosensitive drum. Just like Embodiment 1, the exposure amount is controlled to be small for an area where the residual toner image exists, so that the developer collection performance increases, and the exposure amount is controlled to be large for an area where the residual toner image does not exist, so that the reverse fogging toner is reduced. Further, in Embodiment 2, the exposure amount can be closely controlled in accordance with the density of the toner image in an area where a residual toner image exists, and the exposure amount may be controlled to be lower as the density of the residual toner image is higher. The method to change the back contrast ΔVb is not limited to the method of changing the exposure amount, and, for example, the charging voltage by the charging roller 2 or the developing voltage applied to the developing roller 22 may be changed. The exposure amount control, the charging voltage control and the developing voltage control may be combined as required.

Thereby the residual toner image formed on the photosensitive drum after development when the image forming operation is interrupted, for example, can be collected by the developer container at high collection efficiency, and at the same time, the reverse fogging toner amount that moves to the photosensitive drum 1 can be reduced. Since the reverse fogging toner decreases, it can be prevented that the charging unit is contaminated by the reverse fogging toner attached to the surface of the charging unit.

In Embodiments 1 and 2, the pixel information detection result is calculated based on the image information (density information) sent from the PC (host computer 199). The CPU circuit unit 150 on the engine control unit 210 side controls the exposing unit based on the image information sent from the PC. The same control may be implemented by using output from the exposing unit, a pulse width control amount of the exposing unit, or the like.

### Embodiment 3

In Embodiments 1 and 2, developer collection of the residual toner after development, formed on the photosensitive drum when the image forming operation is interrupted, due to a paper conveying error or the like, was described. In Embodiment 3, a case of developer collection of a toner image formed on the photosensitive drum for a reason different from Embodiments 1 and 2 will be described.

In the process cartridge described thus far, the toner coated on the developing roller repeatedly rubs against the photosensitive drum 1. After repeated rubbing, the toner may be deformed and deteriorated. In order to remove only the deteriorated toner from the surface of the developing roller and the developer container, a toner image is formed on the photosensitive drum, and developer collection is performed for this toner image. This toner discharge control will now be described. In other words, the image forming apparatus 100 of Embodiment 3 can operate in image forming mode, in which a toner image is formed by the image forming unit, and is transferred to the transferred member, and a discharge mode in which toner is discharged to the transferred member.

### Toner Discharge Control

In the control of Embodiment 3 of the present disclosure, deteriorated toner generated while the process cartridge is used (hereafter called “deteriorated toner”) can be efficiently discharged from the developer container, without discharging very much undeteriorated toner (hereafter called “fresh toner”).

Specifically, the control of Embodiment 3 is an operation and a control method characterized in that the toner inside the developer container (containing both deteriorated toner and fresh toner) is discharged from the developer container onto the photosensitive drum 1, then fresh toner is selectively collected by the developing unit, and deteriorated toner is collected by a waste toner container 17 using an intermediate transfer belt cleaning apparatus 16.

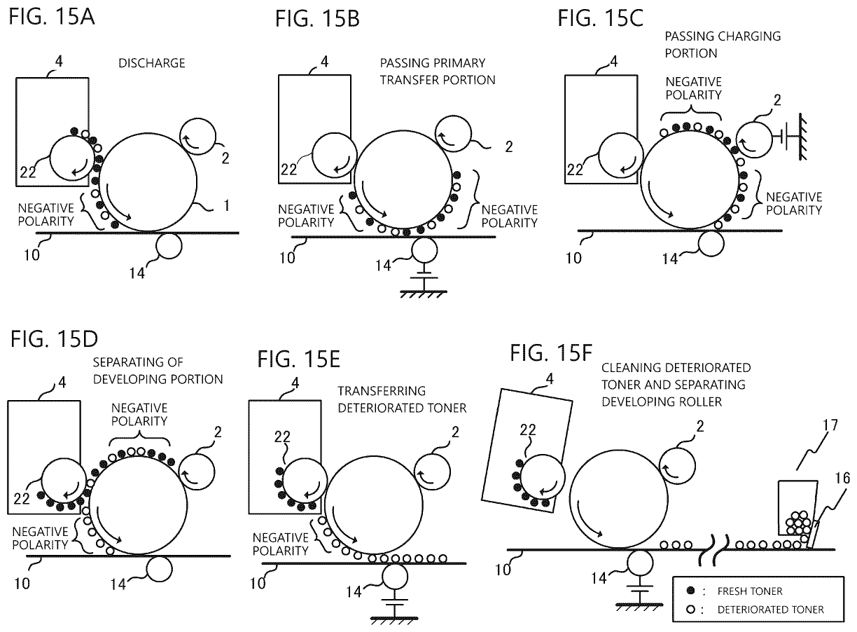

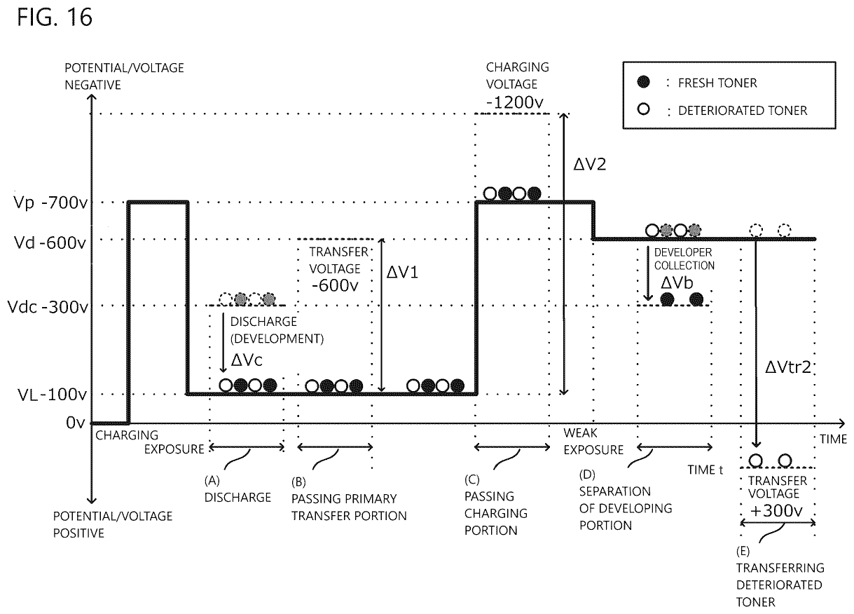

According to the control of Embodiment 3, the deteriorated toner can be selectively discharged from the developer container, while collecting a part of the fresh toner by the developer container, hence efficient discharging can be implemented. As a result, wasteful toner consumption can be prevented. At the same time, the amount of toner collected by the waste toner container 17 can be reduced, hence the waste toner container 17 can be replaced less frequency. This control will now be described with reference to FIGS. 15A to 15F and 16A to 16E. In the following description, the toner discharged from the developer container is called “discharge toner”, and a series of operations is called “discharge control”.

FIGS. 15A to 15F are schematic diagrams for describing the movement of the discharge toner when the discharge control is performed, and FIG. 16 is a diagram schematically indicating the potential, developing voltage and primary transfer voltage of the photosensitive drum 1 and the movement of toner in the discharge control along a time axis. “(A)” to “(E)” in FIG. 16 correspond to FIGS. 15A to 15E respectively. A solid line circle in FIG. 16 indicates toner after movement, and a broken line circle indicate toner before movement. In FIG. 16, Vp indicates “Drum Potential Vp After Charging”. Vd indicates “Drum Potential Vd After Weak Exposure”. Vdc indicates “Developing Voltage Vdc”. VL indicates “Exposing Unit Potential VL”.

This control is generally divided into six steps: <1> discharging toner inside developing device, <2> passing discharge toner through primary transfer portion, <3> passing discharge toner through charging portion, <4> separating toner in developing portion, <5> transferring deteriorated toner, and <6> processing deteriorated toner. Each step will be described below.

### <1> Discharging Toner Inside Developing Device (See FIG. 15A and “(A)” in FIG. 16)

When the operation of the discharge control starts, the photosensitive drum 1 is uniformly charged by the charging roller 2 to a predetermined negative polarity potential (drum potential after charging Vp=−700V) in the rotating process, and is then exposed by the scanner unit 3 (exposing unit). Thereby a latent image potential, that is, exposing unit potential VL (−100V in Embodiment 3), is formed on the photosensitive drum 1.

Then as illustrated in FIG. 15A, at a position where the developing roller 22 and the photosensitive drum 1 contact, toner carried on the developing roller 22 is discharged to the photosensitive drum 1 by the potential difference between the developing voltage Vdc (−300V) and the exposing unit potential VL (this potential difference is called “developing contrast”, and is ΔVc in FIG. 16). In the discharge toner here, the deteriorated toner and the fresh toner are mixed, and in FIGS. 15A to 15F, the deteriorated toner is indicated by white circles, and the fresh toner is indicated by black circles.

In this discharge control, the exposure amount by the exposing unit is differentiated from that of the image forming operation, so that the exposing unit potentials VL and ΔVc become larger than those of the image forming operation. This is for developing the toner on the developing roller 22 on the photosensitive drum 1 with certainty.

The length of discharge toner, which is discharged in one operation, in the rotating direction of the photosensitive drum 1 is preferably a length of one cycle of the developing roller 22 or more, and is less than a length of one cycle of the photosensitive drum 1. The toner existing near the developing roller 22 tends to be consumed easily, hence at least the length of one cycle of the developing roller 22 is preferable, so that all the toner coated on the developing roller 22 is completely discharged before the discharge control is started. On the other hand, if discharged toner inside the developing device and collection of fresh toner by the developing unit (described later) are performed simultaneously, the collection efficiency may drop due to the potential of the photosensitive drum, hence the length of the discharge toner in the rotating direction of the photosensitive drum 1 is preferably within one cycle of the photosensitive drum 1.

In Embodiment 3, a length of toner to be discharged is 44.8 mm (=10 mm×3.14÷1.4×2), which is two cycles of the developing roller 22, and this is less than 62.8 mm (=20 mm×3.14) which is a length of one cycle of the photosensitive drum 1.

The length of the discharge toner, which is discharged in one operation in the rotating direction of the photosensitive drum 1, is limited, but the total discharging toner amount can be adjusted by repeating this discharge control.

### <2> Passing Discharge Toner Through Primary Transfer Portion (See FIG. 15B and “(B)” in FIG. 16)

Then when the discharge toner is passing through the primary transfer portion, a −600V voltage is applied to the primary transfer roller 14 (metal roller) from the primary transfer power supply 15. As indicated in “(B)” in FIG. 16, a potential difference ΔV1, for the discharged toner (normal charging polarity) to remain on the photosensitive drum 1, is formed between the photosensitive drum 1 and the intermediate transfer belt 10 at the primary transfer portion. As a result, discharged toner in a state of being carried on the photosensitive drum 1 passes through the primary transfer portion, as illustrated in FIG. 15B.

If the potential formed on the intermediate transfer belt 10 has negative polarity and of which absolute value is larger than the absolute value of the exposing unit potential VL of the photosensitive drum 1a, the discharge toner can remain on the photosensitive drum 1a. This is because the discharge toner has been charged to the normal charging polarity (negative polarity) by rubbing with the developing blade 23, and therefore is electrostatically attracted to the intermediate transfer belt 10 in which a negative polarity potential, which is larger than the absolute value of the potential of the photosensitive drum 1 (exposing unit drum potential VL), is formed. For the discharge toner to remain on the photosensitive drum 1, the potential difference must be at least the primary transfer contrast ΔVtr1 when the image is formed. If the potential difference ΔV1 is too large, however, the polarity of the discharge toner may be inverted by an abnormal discharge which may be generated in the primary transfer portion, hence in the configuration of Embodiment 3, the potential difference ΔV1 is preferably less than 1500V. In Embodiment 3, a −600V potential is formed on the intermediate transfer belt 10 by the primary transfer power supply 15, so that the absolute value of the potential difference ΔV1 becomes 500V.

### <3> Passing Discharge Toner Through Charging Portion (See FIG. 15C and “(C)” in FIG. 16)

Then the discharge toner, which passed through the primary transfer portion, passes through a position (charging portion) where the charging roller 2 and the photosensitive drum 1 contact. As indicated in “(C)” in FIG. 16, when the discharge toner passes through the charging portion, a −1200V negative polarity voltage is applied to the charging roller 2. As a result, because of the potential difference ΔV2 between the potential of the photosensitive drum 1 and the voltage of the charging roller 2 (hereafter called “charging contrast ΔV2”), the discharge toner can pass without adhering to the charging roller 2. At the same time, the drum potential Vp, after charging, is formed, and charges are provided to the discharge toner.

In any of the above aspects, the charging contrast ΔV2 is preferably large enough to be equivalent to the charging contrast when an image is formed. If the charging contrast ΔV2 is too large, however, toner polarity may be inverted by the abnormal discharge which may be generated in the charging portion, and discharge toner may adhere to the charging roller 2. Hence in Embodiment 3, the charging contrast ΔV2 is set to be 1100V.

### <4> Separating Toner in Developing Portion (See FIG. 15D and “(D)” in FIG. 16)

Separation of deteriorated toner and fresh toner at a position where the developing roller 22 and the photosensitive drum 1 contact (hereafter called “developing portion”), which is a characteristic portion of Embodiment 3, will be described next. The discharge toner, which passed through the charging portion, passes through the developing portion. Here developing voltage Vdc=−300V is applied to the developing roller 22, as indicated in “(D)” in FIG. 16, and potential Vd=−600V is formed on the surface of the photosensitive drum by weak exposure. The discharge toner is collected by the potential difference ΔVb between this drum potential Vd after weak exposure, and the developing voltage Vdc.

The discharge toner includes both fresh toner and deteriorated toner. The deteriorated toner is generated by rubbing with the developing blade 23 for a long time, where toner particle shapes are deformed, or an external additive on the toner surface is stripped or embedded. If toner particle shapes are deformed, the contact area of the toner and the photosensitive drum 1 increases. For example, if an external additive on the surface of toner particles is stripped, the resin component of the toner and the photosensitive drum 1 directly contact, and the external additive may be embedded in the toner, whereby the contact area between the toner and the photosensitive drum 1 increases. As a result, the non-electrostatic adhesive force of the deteriorated toner with the photosensitive drum 1 becomes higher than that of fresh toner. The fresh toner, on the other hand, which has not deteriorated very much, adheres to the photosensitive drum 1 much less than the deteriorated toner. Hence the fresh toner is more easily collected and the deteriorated toner is less likely to be collected, at the developing portion of the discharge toner.

Embodiment 3 is characterized in that the fresh toner is selectively collected (deteriorated toner is not selectively collected) at the developing portion, as illustrated in FIG. 15D, using the difference of the non-electrostatic adhesive force between the deteriorated toner and the fresh toner. Out of the discharge toner, most of the fresh toner, which has not deteriorated very much, can be collected, hence the life of the developing apparatus can be extended without wasting toner. In Embodiment 3, a BET value of the fresh toner is about 2.8 m²/g, and a BET value of the deteriorated toner is about 2.0 m²/g or less, for example. However this step allows separating toners even in the case where the difference in the non-electrostatic adhesive forces is 0.8 m²/g or less in BET values. In other words, this kind of selective toner discharge can be performed even when the difference in non-electrostatic adhesive forces is small (e.g. initial phase when a number of feeding sheets is low, and durability is high). Generally as durability decreases and a number of feeding sheets increases, deterioration progresses, hence the effect of performing this sequence is more conspicuous in the period when the number of feeding sheets becomes high (e.g. middle to latter durability).

The discharge toner collection efficiency to collect discharge toner by the developing roller 22 can be controlled by the potential difference ΔVb. As the absolute value of the potential difference ΔVb increases in a range less than the discharge threshold, the electric field, to move the discharge toner to the developing roller 22 side, increases, hence the collection efficiency improves. If the potential difference ΔVb is larger than the discharge threshold between the developing roller 22 and the photosensitive drum 1, the polarity of the discharge toner is inverted by discharging, and collection efficiency drops. If the absolute value of the potential difference ΔVb is small, not only does the collection efficiency drop, but also toner coated on the developing roller 22 can no longer be held on the developing roller 22, and the toner is developed on the photosensitive drum 1 (this unintended phenomena is called “fogging”). As mentioned above, the potential difference ΔVb must be set to a range less than the discharge threshold where fogging is not generated, and also be set such that the fresh toner can be selectively collected by the developing roller 22. The potential difference ΔVb can be 100V or more and less than 500V, and may be appropriately adjusted depending on the characteristics of the toner in sue (adhesive force, charging amount, shape, degree of deterioration, and the like).

In the case of the toner T used in Embodiment 3, the voltage to be applied to the developing roller 22 is set to −300V, so that the absolute value of the potential difference ΔVb becomes 300V. In Embodiment 3, the back contrast ΔVb is generated by weak exposure, but the present disclosure is not limited to this, and in the case of the image forming apparatus 100 which does not include weak exposure, the appropriate charging contrast ΔV2 and the back contrast ΔVb may be implemented by adjusting the charging voltage.

As described above, most of the fresh toner can be collected by the developing roller 22, and most of the deteriorated toner can remain on the photosensitive drum 1.

### <5> Transferring Deteriorated Toner (See FIG. 15E and “(E)” in FIG. 16)

After the separation collection step in the developing portion, the deteriorated toner remaining on the photosensitive drum 1 is transferred to the intermediate transfer belt 10. The deteriorated toner which passed through the developing portion as been charged to negative polarity (normal charging polarity), hence as illustrated in FIG. 15E, positive primary transfer voltage to transfer the deteriorated toner is applied, whereby the deteriorated toner is transferred to the intermediate transfer belt 10. As indicated in “(E)” in FIG. 16, the potential on the surface of the photosensitive drum 1, where the deteriorated toner remains, is the drum potential Vd after weak exposure, and the deteriorated toner is transferred to the intermediate transfer belt 10 by the potential difference ΔVtr2 between Vd and the primary transfer voltage Vtr.

In the transfer of the deteriorated toner to the intermediate transfer belt 10, the adhesive force of the deteriorated toner to the photosensitive drum 1 is high, as mentioned above, hence transfer to the intermediate transfer belt 10 is difficult if the potential difference is similar to that during normal image formation. Therefore the potential difference ΔVtr2 must be set such that the deteriorated toner can be transferred to the intermediate transfer belt 10 with certainty. Here the deteriorated toner remaining on the photosensitive drum 1 is toner which was not collected by the developing roller 22 by the potential difference ΔVb in the previous toner collection step by the developing roller 22, hence it is preferable to set the potential difference ΔVtr2 to at least the back contrast ΔVb which is used during developer collection for fresh toner. Further, as mentioned above, the deteriorated toner has a strong adhesive force to the photosensitive drum 1, and is not easily transferred. Therefore the potential difference ΔVtr2 is preferably larger than the transfer contrast ΔVtr1 which is used during normal image forming operation. In other words, it is preferable that the potential difference ΔVtr2 is larger than a larger potential difference of the back contrast ΔVb which is used during developer collection of fresh toner and the transfer contrast ΔVtr1 which is used during a normal image forming operation. If the potential difference ΔVtr2 is too large, however, abnormal discharge may be generated in the primary transfer portion, hence ΔVtr2 is preferably less than 2000V.

In Embodiment 3, the deteriorated toner is transferred to the intermediate transfer belt 10 at ΔVtr2=900V, which is the potential difference between the drum potential Vd=−600V after weak exposure, and the primary transfer voltage Vtr=+300V.

### <6> Processing Deteriorated Toner (See FIG. 15F)

Finally the processing of the deteriorated toner transferred onto the intermediate transfer belt will be described with reference to FIG. 15F.

The transferred deteriorated toner is sent to the intermediate transfer belt cleaning apparatus 16 by rotation of the intermediate transfer belt 10, and is collected by and processed in the waste toner container 17. Since a part of the discharged toner, containing a large amount of deteriorated toner, can be sent to the waste toner container 17, the waste toner container 17 becomes full much more slowly compared with the case of transferring all the discharged toner to the waste toner container 17. This means that the user can replace the waste toner container 17 less frequently.

When the discharge toner has passed the developing portion (state between FIGS. 15E and 15F), the developing roller 22 is immediately separated from the photosensitive drum 1, and rotation of the developing roller 22 is stopped. This is because toner on the developing roller 22 is rubbed by the developing blade 23 as the developing roller 22 rotates, and this unnecessary rubbing can be prevented by immediately separating the developing roller 22 from the photosensitive drum 1 at the timing when contact therebetween is no longer necessary.

In Embodiment 3, when the deteriorated toner charged to the negative polarity, which is on the intermediate transfer belt 10 of the intermediate transfer belt cleaning apparatus 16, is sent to the intermediate transfer belt cleaning apparatus 16, negative polarity voltage is applied to the secondary transfer roller 20, so that the deteriorated toner passes through without adhering to the secondary transfer roller 20.

In Embodiment 3, when the deteriorated toner passes through the secondary transfer roller 20, voltage is applied to the secondary transfer roller 20, so that the deteriorated toner does not adhere to the secondary transfer roller 20. If the absolute value of the applied voltage to the secondary transfer roller 20 here is too small, the deteriorated toner adheres to the secondary transfer roller 20. If it is too large, however, the toner polarity is inverted by abnormal discharge, and the deteriorated toner adheres to the secondary transfer roller 20 as well. Therefore the applied voltage to the secondary transfer roller 20 is preferably about −300 to −1000V, and in Embodiment 3, a −500V voltage is applied to the secondary transfer roller 20. In Embodiment 3, the secondary transfer roller 20 is contacted with the intermediate transfer belt 10. However if a mechanism to separate the secondary transfer roller 20 is included, the adhesion of the deteriorated toner to the secondary transfer roller 20 may be prevented by separating the secondary transfer roller 20 from the intermediate transfer belt 10.

The deteriorated toner transferred onto the intermediate transfer belt 10 may not always be sent to the intermediate transfer belt cleaning apparatus 16 during the discharge control. For example, the deteriorated toner is transferred onto the intermediate transfer belt 10 and the discharge control may end at this point. The deteriorated toner remaining on the intermediate transfer belt 10 may be sent to the intermediate transfer belt cleaning apparatus 16, by the next rotating operation of a regular image forming operation, and be collected and processed thereby. In this case, the discharge control can be executed without generating unnecessary down time.

In the discharge mode of Embodiment 3, the developing voltage is the same as Vdc=−300V, which is the same as in the image forming operation, and the charging voltage, exposure amount and the like are different from those in the image forming operation. The present disclosure, however, is not limited to this, and the developing voltage Vdc may be changed in order to change ΔVb and ΔVc.

### Average Print Percentage

The ratio of deteriorated toner and fresh toner on the developing roller or inside the developer container changes depending on the history of images that were printed. In the longitudinal direction intersecting orthogonally with the paper conveying direction, fresh toner is consumed before becoming deteriorated toner in an area where toner usage is high, hence the ratio of the deteriorated toner is low. In an area where toner usage is low, toner remaining for a long time in the developer container and on the developing roller increases, hence the ratio of the deteriorated toner is high.

According to Embodiment 3, the longitudinal direction (direction intersecting orthogonally with the paper conveying direction) of a paper area is divided into a plurality of areas, and an average print percentage is calculated for each area, then the ratio of the deteriorated toner is calculated for each area. This method will be described.

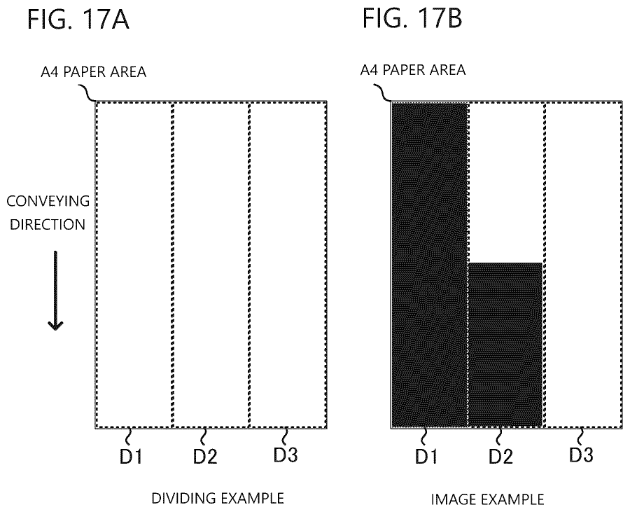

FIG. 17A indicates the dividing example of an A4 paper area. Here the A4 paper area is divided into a plurality of areas (three areas in this case) in the longitudinal direction. The areas are defined as D1 area, D2 area and D3 area in order from the left. The A4 paper area is 210 mm W×297 mm L. The size of each area is equally 70 mm×297 mm. However the size of each area may be different from each other, and a number of divided areas may be increased. In the case of 600 dpi, each area of this example is constituted of 1654×7016=11604464 pixels.

In the image illustrated in FIG. 17B, a count rule of a number of pixels will be explained using a case of a Bk process cartridge. Each pixel has density information in the 0 to 255 range. In each area of D1, D2 and D3, a total number of pixels of which density information is larger than 0 is calculated. Since a number of pixels in which toner exists is counted, the total number to be calculated is also called “total number of toner pixels”.

In FIG. 17B, the entire D1 area is a black solid image, half of the D2 area is a black sold image, and no pixels having density information exist in the D3 area. “Solid” means an area where a set of pixels having a density information of 255 exists. A total number of pixels in each area is 11604464 in the D1 area, 5802232 in the D2 area, and 0 in the D3 area. A value determined by dividing a total number of toner pixels by a total number of pixels in each area and then multiplying by 100 is regarded as a print percentage. The print percentage in each area is calculated for each feeding sheet, and the average print percentage in each area is calculated. In this case, the engine control unit 210, which functions as image information acquiring unit, divides the image area into a plurality of areas separated by boundary lines in the rotating direction of the photosensitive drum 1, and calculates an average print percentage in each of the plurality of areas.

### Average Print Percentage and Deteriorated Toner Ratio

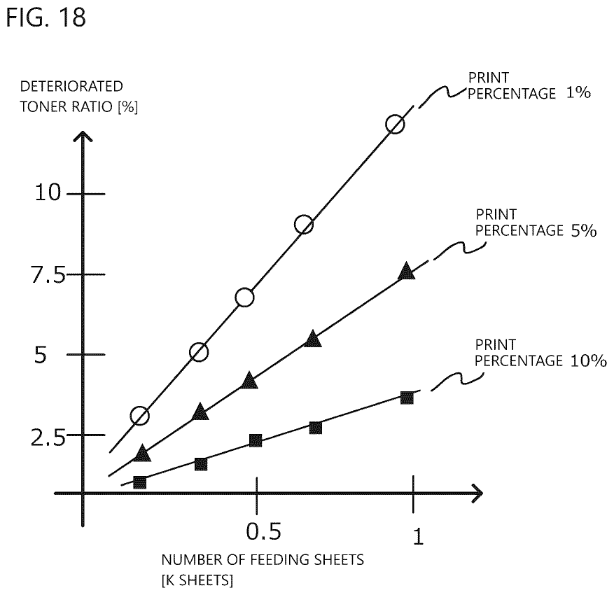

FIG. 18 indicates a number of feeding sheets and a deteriorated toner ratio on the developing roller. Three types of images of which print percentages area different (1, 5, 10%) are prepared, and paper feeding is repeated until 1K sheets of paper are fed. All the density information of pixels to be printed is 255. In this process of feeding 1K sheets, toner on the developing roller is sampled, and a ratio of the deformed and deteriorated toner is calculated. To calculate the ratio of the deteriorated toner, the average circularity (aspect ratio) of the sampled toner is checked using EPIA-3000. Here deterioration is determined if the average circularity is 0.9 or less.

As a result of testing, it was confirmed that the ratio of deteriorated toner is lower as the print percentage is higher. In the case of high print percentage, the fresh toner coated on the surface of the developing roller moves to the photosensitive drum 1 before changing into deteriorated toner, then moves to the intermediate transfer belt 10 and is transferred and fixed to the paper. The ratio of deteriorated toner is low probably because toner has little chance to deteriorate. In the case of low print percentage, on the other hand, toner coated on the surface of the developing roller has little chance to move to paper. Therefore the toner is more frequently rubbed between the developing roller 22 and the photosensitive drum, and this is probably the reason why the ratio of the deteriorated toner is high.

A possible reason why the print percentage and the deteriorated toner ratio are not proportional will be described. In the case where the print percentage is low, the area outside the print region is wide. Fogging toner is discharged to this area. The print percentage however is not a value that takes fogging toner into consideration. The fogging toner amount changes depending on the print percentage. This is probably because the print percentage and the deteriorated toner ratio are not proportional.

### Deteriorated Toner Level and Toner Discharge Pattern

As described above, the relationship between the average print percentage and the deteriorated toner was checked. It became clear that the deteriorated toner ratio is higher as the average print percentage is lower. The toner discharge pattern, when the toner discharge control is performed, may be a pattern having the same density in the entire area, but it is preferable that the toner discharge control is performed using a toner discharge pattern in accordance with the ratio of deteriorated toner if this ratio can be calculated.

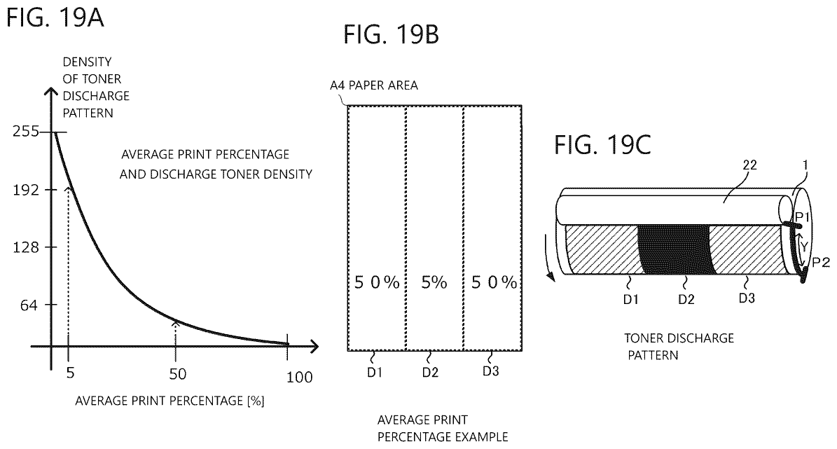

In Embodiment 3, the toner discharge control is executed based on the relationship between the average print percentage and the density of the toner discharge pattern indicated in FIG. 19A. In the case where the average print percentage is low and the amount of the deteriorated toner is high, the density of the toner discharge pattern is controlled to be high, and in the case where the average print percentage is high and the amount of the deteriorated toner is low, the density of the toner discharge pattern is controlled to be low. FIG. 19B indicates the average print percentages of the areas D1, D2 and D3 determined by equally dividing the paper into three. The average print percentages in D1, D2 and D3 are 50, 5 and 50% respectively. FIG. 19C indicates the toner discharge patterns in this case. The toner discharge patterns at the positions corresponding to the D1 and D3 areas are indicated by shaded portions, and the toner discharge pattern at the position corresponding to the D2 area is indicated by a solid black portion. The density information of the shaded portions is 40, and the density information of the solid black portion is 194.

The reason why the toner discharge pattern density adjustment is executed in accordance with the average print percentage will be described. In some cases, when the toner discharge is controlled, a small amount of fresh toner may be moved to the intermediate transfer belt although only deteriorated toner is basically moved to the intermediate transfer belt. If the amount of deteriorated toner in the discharged toner image is low, it is probably better to control the density of the toner discharge pattern to be low, to prevent the loss of fresh toner. If it is known that the amount of deteriorated toner in the toner discharge pattern is high in advance, then a large amount of deteriorated toner must be removed in one toner discharge control cycle. Therefore it is preferable that the density of the toner discharge pattern is set to be high.

As described above, in the toner discharge control, the density of the toner discharge pattern is changed in accordance with the deteriorated toner ratio, whereby both reducing the risk of losing fresh toner and the high efficiency removal of deteriorated toner can be implemented.

In the toner discharge control described in Embodiment 3, toner images having different densities are formed on the photosensitive drum, and these toner image are returned to the developing roller 22. In this case as well, an effect similar to the control described in Embodiment 2 can be exhibited. As described in Embodiment 2, if the back contrast ΔVb value before the developer collection is controlled in accordance with the density (amount) of the toner image on the photosensitive drum, unnecessary toner formed on the photosensitive drum can be collected by the developer container at a high collection efficiency, and at the same time, the reverse fogging toner amount that moves to the photosensitive drum 1 can be reduced. Since reverse fogging toner decreases, it can be prevented that the reverse fogging toner adheres to the surface of the charging unit and contaminates the charging unit.

According to the present disclosure, in the image forming apparatus that collects the toner on the photosensitive drum by the developing roller, both efficient developer collection and reduction of reverse fogging toner amount can be implemented.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-157751, filed Sep. 11, 2024, which is hereby incorporated by reference herein in its entirety.

What is claimed is:

1. An image forming apparatus comprising:
an image bearing member;
a charging unit for charging the image bearing member;
an exposing unit for exposing the image bearing member and forming an electrostatic latent image;
a developing unit for supplying toner to the electrostatic latent image on the image bearing member and forming a toner image;
a transfer unit for transferring the toner image formed on the image bearing member to a transferred member;
a control unit configured to control charging voltage applied to the charging unit, developing voltage applied to the developing unit, transfer voltage applied to the transfer unit, and exposure amount by the exposing unit; and
an image information acquiring unit for acquiring information related to density of the toner image formed on the image bearing member, wherein
in a collected area which is a predetermined range of the image bearing member in a direction along a rotating shaft line thereof, the control unit can perform developer collection, that is, returning the toner image formed on the image bearing member to the developing unit without transferring the toner image onto the transferred member,
in a case where an absolute value of a difference between a surface potential of the image bearing member to return the toner image to the developing unit and the developing voltage defines a back contrast, the image information acquiring unit sets a first area and a second area in which density of toner is higher than the first area, to be disposed in a direction along the rotating shaft line in the collected area, and
the control unit performs control so that a second back contrast of the second area during the developer collection is higher than a first back contrast of the first area.

2. The image forming apparatus according to claim 1, wherein
the image information acquiring unit detects the density of the toner for each pixel in the collected area, and
the exposing unit can perform first exposure, which is exposure to form the toner image, and second exposure, which is exposure to perform the developer collection, and controls the back contrast by adjusting light quantity of the second exposure in accordance with the density of the toner of the pixel.

3. The image forming apparatus according to claim 2, wherein
the exposing unit adjusts exposure amount to be lower in a case of performing the second exposure in the second area, compared with a case of performing the second exposure in the first area.

4. The image forming apparatus according to claim 2, wherein
the image information acquiring unit sets a pixel, in which toner supplied from the developing unit does not exist, to the first area, and a pixel, in which toner supplied from the developing unit exists, to the second area.

5. The image forming apparatus according to claim 1, wherein
a plurality of image forming units each of which includes the image bearing member, the charging unit and the developing unit, are provided, and the plurality of image forming units supply the toner having mutually different colors respectively, and
the transferred member is an intermediate transfer member onto which the toner images formed by the plurality of image forming units are transferred.

6. The image forming apparatus according to claim 1, wherein
the control unit performs the developer collection in a case where an image forming operation is interrupted in the middle of transferring the toner image formed on the image bearing member onto the transferred member.

7. The image forming apparatus according to claim 1, wherein
the exposing unit performs exposure in the developer collection, by moving a position of exposure on the image bearing member in a main scanning direction which is along the rotating shaft line of the image bearing member and a sub-scanning direction which crosses the main scanning direction, and
the control unit sets the first area and the second area for each main scanning step in the main scanning direction.

8. An image forming apparatus comprising:
an image bearing member configured to be rotatable;
a charging unit for charging the image bearing member;
an exposing unit for exposing the image bearing member and forming an electrostatic latent image;
a developing unit for supplying toner to the electrostatic latent image on the image bearing member and forming a toner image;
a transfer unit for transferring the toner image formed on the image bearing member to a transferred member;
a control unit configured to control charging voltage applied to the charging unit, developing voltage applied to the developing unit, transfer voltage applied to the transfer unit, and exposure amount by the exposing unit; and
an image information acquiring unit for acquiring information related to the toner image formed on the image bearing member, wherein
the charging unit, the exposing unit, the developing unit and the transfer unit are disposed in order from an upstream side in a rotating direction of the image bearing member, and
the image forming apparatus can operate in an image forming mode in which the toner image formed on the image bearing member is transferred onto the transferred member, and a discharge mode in which the developing unit supplies discharge doner to the image bearing member, and the developing unit collects a part of the discharge toner and transfers another part of the discharge toner onto the transferred member, wherein
in the discharge mode, the image information acquiring unit divides the toner image into a plurality of areas, calculates an average print percentage in each of the plurality of areas as information on the toner image, and the control unit controls density of the discharge toner for each area based on the average print percentage.

9. The image forming apparatus according to claim 8, wherein
the image information acquiring unit divides the toner image into a plurality of areas in which boundary lines are formed in a direction along the rotating direction.

10. The image forming apparatus according to claim 9, wherein
in the discharge mode, the control unit supplies the discharge toner such that the density of the discharge toner is higher as the average print percentage of the area is higher.
